(19) United States
(12) Patent Application Publication
(10) Pub. No.: US 2025/0176493 A1
(43) Pub. Date: Jun. 5, 2025

(54) ANIMAL TRANSPORT CAGE

(71) Applicant: Thule Sweden AB, Hillerstorp (SE)

(72) Inventors: Markus NORDANGÅRD, Värnamo (SE); Micael LYREBORG, Åsarp (SE); Anton ARVIDSSON-BJÖRKMAN, Lekeryd (SE); Adam GUSTAFSSON, Jönköping (SE); Henrik ERIKSSON, Jönköping (SE); Micael APELBY, Jönköping (SE)

(21) Appl. No.: 18/862,019

(22) PCT Filed: Apr. 24, 2023
(86) PCT No.: PCT/EP2023/060641

§ 371 Date: Oct. 31, 2024

(30) Foreign Application Priority Data
May 3, 2022 (EP) 22171358.9

(51) Int. Cl. A01K 1/02

(52) U.S. Cl. CPC A01K 1/0245; A01K 1/0272

(57) ABSTRACT

An animal crate for transporting an animal in a vehicle. The animal crate includes a bottom and a top connected by a frame assembly. The frame assembly comprises a front portion, a rear portion, and an elongate member connected to the front portion and the rear portion. The front portion and the rear portion are configured to translate relative to each other in a longitudinal direction.

### TECHNICAL FIELD

The present disclosure relates animal cages or crates for keeping animals during transport. More particularly, the present invention relates to an animal cage suitable for use for transportation of an animal in a vehicle.

### BACKGROUND OF THE INVENTION

Animal cages or crates are typically used for keeping animals during short periods of time and/or during transportation for instance in vehicles. It is often desired and, in some countries, also a requirement that animals are kept in cages during transportation inside of a vehicle, not only for the safety of the animal but also for the safety of the other occupants of vehicle. Naturally, an animal cage should be designed with the animal in mind to allow it to be as calm and comfortable as possible when kept in the cage.

Additionally, animal cages intended for use in vehicles are subject to a number of safety requirements. Generally, an animal cage must withstand the forces of an accident such that the animal kept therein is to at least some extent protected and such that it cannot be ejected from the cage by the forces which may arise in an accident. Additionally, the components of the animal cage itself must not become detached as free flying items in a vehicle under significant acceleration/deceleration can form dangerous projectiles.

Naturally, an animal cage should make efficient use of space in that it should provide a large interior for the animal while the exterior of the cage should take up as little space as possible for instance in a vehicle. Additionally, an animal cage should be easy to use and allow easy entry and exit for the animal even in the case that the owner of the animal have to carry the animal into the cage. Prior art animal cages has been found to leave room for improvement in at least some of the foregoing areas.

### SUMMARY OF THE INVENTION

In view of the above, an object of the present invention is to provide an improved animal cage which alleviates at least one of the drawbacks of the prior art. For example, an object of the present invention is to provide an animal cage having improved safety over prior art animal cages. Additionally, it is an object of the present invention to provide an animal cage facilitating placement and removal of the animal from the animal cage. Moreover, it is an object of the present invention to facilitate removal/evacuation of an animal from the case for instance in the case of an accident.

The object is achieved by the subject-matter of independent claim 1. Advantageous embodiments may be found in the dependent claims and in the accompanying description and drawings.

In a first aspect is an animal cage suitable for use for transportation of an animal in a vehicle provided. The animal cage comprising:
a bottom,
a top,
a frame assembly connecting the bottom to the top. The frame assembly comprising a front portion and a rear portion, the front portion and rear portion being reciprocally moveable relative one another along a longitudinal direction of the animal cage such that a length of the animal cage may be adapted and wherein the animal cage comprises at least one resistance altering element having at least one pre-set force state for altering a longitudinal force required for relative movement of the front and rear portion. By providing the resistance altering element can the cage be adjusted in size as desired depending on the size of the animal to be transported and/or the size of the vehicle. Additionally, the required force for relative movement of the front and rear portion can be controlled to allow relative movement of the front and rear portion in the case of for instance an accident causing a rapid acceleration/deceleration, allowing the animal cage to better withstand the forces associated with such an event. The animal cage is thus made both safer and more user friendly.

The resistance altering element may be set to at least a high force state in which the longitudinal force required for relative movement of the front and rear portion is high and a low force state in which the longitudinal force required for relative movement of the front and rear portion is low relative the high force state. The predetermined high and low force state of the resistance altering element facilitates providing the desired safety of the animal cage, while allowing the user to adjust the size of the animal cage when desired.

The resistance altering element may comprise a clamp mechanism configured to alter a pressure applied to an interface for controlling an induced friction force thus altering the longitudinal force required for relative movement of the front and rear portion.

The frame assembly may comprise at least one telescopic element extending between the front portion and the rear portion and wherein at least one of the at least one telescopic element is provided with the resistance altering element. The telescopic element being provided with the resistance altering element facilitates adjusting the resistance altering element and thus the size of the animal cage.

The frame assembly may comprise a plurality of telescopic elements provided on each lateral side of the animal cage, the telescopic elements may be formed as side enclosure bars of the animal cage.

At least one telescopic element on each lateral side of the animal cage may be provided with a resistance altering element, thus allowing the animal cage to absorb a longitudinal force evenly on both lateral sides and facilitating the reciprocal relative movement of the front and rear portion in the longitudinal direction.

The clamp mechanism may be configured to be set in a clamping state in which the pressure applied to the interface is high and in a released state in which the pressure applied to the interface is low.

The resistance altering element may comprise a cam surface configured to alter the force required for telescopic movement of the front and rear portion.

The clamp mechanism may control the position of the cam surface.

The longitudinal force required for achieving relative movement of the front and rear portion in the high force state may correspond to at least half of a total weight of the animal cage, thus ensuring that relative movement of the first and rear portion occurs in the case of an accident which absorbs the forces acting on the animal cage in the longitudinal direction thereof. The risk of damage to the animal cage is thus reduced in the case of an accident as well as the safety for the animal kept in the cage.

The longitudinal force required for achieving relative movement of the front and rear portion in the high force state is between 50 N and 200 N.

The telescopic element provided with the resistance altering element may be arranged at a height from the bottom of the animal cage in the proximity of a height from the bottom of the animal cage of a center of gravity of said animal cage. The longitudinal force causing relative movement of front and rear portion of the animal cage, for instance in the case of an accident, it thus more likely to be focused in the telescopic element having the resistance altering element. As such, the relative movement of the front and rear portion is made more reliable and accordingly is the safety of the animal cage improved.

The telescopic element may be provided with the resistance altering element arranged at a height from the bottom of the animal cage that is essentially half of a total height of the animal cage. The longitudinal force causing relative movement of front and rear portion of the animal cage, for instance in the case of an accident, it thus more likely to be focused in the telescopic element having the resistance altering element. As such, the relative movement of the front and rear portion is made more reliable and accordingly is the safety of the animal cage improved.

The animal cage may further comprises a stop element being configured to form a limit for the relative movement of the front and rear portion such that the front portion and rear portion cannot move past a first relative position and wherein the stop element is configured to allow movement of the front portion and rear portion past the first relative position when the animal cage is subjected to a longitudinal force being higher than a threshold value. The force is preferably more than the force required for achieving relative movement of the front and rear portion in the low force state of the resistance altering element. The user can thus adjust the animal cage to any size setting without risking that the relative movement of the first and rear portion is effected, thus providing the desired safety to the animal cage while providing the user with the freedom to adjust the animal cage as desired. The first relative position may thus be a smallest size of the animal cage, i.e. when the front portion and the rear portion is as close together as allowed by the stop element.

The threshold value of the longitudinal force may be at least half of the weight of the animal cage.

In a second aspect is an animal cage suitable for use for transportation of an animal in a vehicle provided, the animal cage comprising:
a bottom,
a top,
a frame assembly connecting the bottom to the top, the frame assembly comprising a front portion and a rear portion,
a cage access opening at least in the front portion, the cage access opening being provided with an access door being pivotable in relation to the front portion,
an access door motion control mechanism being configured to provide a moment of force that varies with the opening angle of the access door. As such, the movement of the access door can be adapted to facilitate opening and maintaining of an open position at larger opening angles of the door. Moreover, the motion control mechanism can allow the access door to automatically close at smaller opening angles.

The motion control mechanism may be configured to increase the moment of force in the opening direction of the access door with increasing opening angle of the access door, facilitating access to the cage access opening and reducing the need for the user to have to manually move the door at larger opening angles.

The motion control mechanism may comprise a constant force spring.

The moment of force of the motion control mechanism in the opening direction in or near a closed position of the access door may be less than a moment of force required to move the access door in the opening direction, thus allowing the access door to self-close.

A hinge of the access door may be arranged at an angle in relation to a vertical direction such that the access door in opening angles less than 90° is biased into the closed position, further facilitating self-closing of the access door.

The motion control mechanism may be arranged between the frame assembly and the access door such that a moment of force in the opening direction is less near the closed position of the door and increases in an opening direction of the access door.

A closing moment of force acting in the closing direction from the weight of the access door may overcome the opening moment of force at least at opening angles less than 20° thus allowing automatic access door closing.

The constant force spring may be arranged at a hinged side of the access door and wherein an angle between an axial direction of the constant force spring in which the force from the constant spring acts and a hinge of the access door increases with increased opening angle of the access door, thus providing a larger moment of force with an increased opening angle for a given axial force from the motion control mechanism.

At least one end of the constant force spring may be attached to the animal cage by means of a ball joint.

A lever arm distance between a hinge of the access door and an axial direction of the motion control mechanism may increase with increased opening angle at least between 0° and 90° opening angle thereof, thus increasing the opening moment of force for a given axial force provided by the motion control mechanism.

The lever arm distance D4 may be such that the motion control mechanism provides a closing moment of force in a closed position of the access door, thus facilitating closing of the access door.

In a third aspect is an animal cage suitable for use for transportation of an animal in a vehicle provided, said animal cage comprising:
a bottom,
a top,
a frame assembly connecting the bottom to the top, the frame assembly comprising a front portion and a rear portion,
at least one animal evacuation hatch configured to allow extraction of the animal in case of emergency. The animal evacuation hatch comprising a latching arrangement being configured to secure the evacuation hatch in relation to the frame assembly such that the evacuation hatch can be locked in place automatically by the latching arrangement when brought into a predetermined position in relation to the frame assembly. An evacuation hatch is thus provided which facilitates extraction of the animal kept in the cage, for instance in case of an incident which makes the main access door unusable. The evacuation hatch being automatically locked in place facilitates arranging the evacuation hatch correctly in relation to the cage.

The evacuation hatch may be arranged in the rear portion of the animal cage.

The latching arrangement may comprise a first and a second latching arrangement arranged at opposite lateral sides of the evacuation hatch, thus reducing the risk of that the evacuation hatch is unintentionally opened and facilitating opening of the evacuation hatch when needed.

Each latching arrangement may comprise a latching pin moveable between an extended and retracted position.

Each latching pin may comprise a handle for moving both the latching pin and the evacuation hatch, whereby the evacuation hatch can be handled, opened and lifted away from the animal cage by the handles arranged on the latching pin.

Each latching pin may be biased into the extended position, thus facilitating locking the evacuation in place in the predetermined position in relation to the animal cage.

The rear portion may comprise laterally opposite abutment surfaces being inclined such that a horizontal distance between the opposite abutment surfaces decreases in the longitudinal direction towards the front portion and wherein the evacuation hatch comprises a first and second lateral flange on opposite lateral sides of the evacuation hatch being configured to abut against the abutment surfaces to limit a forward movement of the evacuation hatch towards the front portion.

Each latching pin may be configured to slide against a respective one of opposite abutment surfaces of the rear portion, the opposite abutment surfaces being inclined such that a horizontal distance between the opposite abutment surfaces decreases in the longitudinal direction towards the front portion, whereby each latching pin is moved out of its extended position until it passes the rear portion whereby the latching pin extends and locks the evacuation hatch in place. The arrangement of the evacuation hatch and locking thereof in the predetermined position is thus facilitated, as each latching pin retracts and extends as it passes the rear portion as the evacuation hatch is moved into the predetermined position by the user.

The evacuation hatch may comprise a lower flange extending along a lower edge thereof, the lower flange being configured to form a stop for preventing the lower edge of the evacuation hatch to move away from the front portion.

The lower flange may form a stepped surface being offset from the remaining evacuation hatch, the lower flange forming a pivot point around which the evacuation hatch can pivot, thus facilitating arranged the evacuation hatch in the predetermined position as well as opening and removal of the evacuation hatch.

In a fourth aspect is an animal cage suitable for use for transportation of an animal in a vehicle provided, the animal cage comprising:
a bottom,
a top,
a frame assembly connecting the bottom to the top, the frame assembly comprising a front portion and a rear portion, the front portion and rear portion being reciprocally moveable along a longitudinal direction such that a length of the animal cage may be adapted, wherein the animal cage further comprises a stop element being configured to form a limit for the telescopic movement of the front and rear portion such that the front portion and rear portion cannot move past a first relative position and wherein the stop element is configured to allow relative movement of the front portion and rear portion past the first relative position when the animal cage is subjected to a force in the longitudinal direction being higher than a threshold value. The relative movement past the first relative position when the animal force is subjected to a force higher than a threshold value enables provision of an animal cage that can be adjusted in size by a user while reducing the risk that such adjustment adversely affects the safety of the animal cage.

The stop element may comprise at least one pin being configured to be sheared of by telescopic relative movement between the front portion and rear portion in case the animal cage is subjected to a force in the longitudinal direction being higher than the threshold value.

The bottom may comprise a front bottom portion and a rear bottom portion and the top may comprise a front top portion and a rear top portion, the top and bottom being telescopically moveable in the longitudinal direction of the animal cage, wherein a stop element is provided in the bottom and/or top such that relative movement of the front portion of the frame arrangement and the rear portion of the frame arrangement past the first relative position is only possible when the animal cage is subjected to a force in the longitudinal direction being higher than the threshold value.

The frame assembly may comprise at least one telescopic element extending between the front portion and the rear portion, wherein a stop element is provided in a front telescopic portion and/or rear telescopic portion in at least one of the at least one telescopic element such that movement of the front portion and the rear portion past the first relative position is only possible when the animal cage is subjected to a force in the longitudinal direction being higher than the threshold value.

The pin may be configured to cooperate with a slot such that the extension of the slot defines the first position and wherein the pin is configured to be sheared of by engagement of an end of the slot.

The pin may be configured to be sheared before plastic deformation is achieved in the slot, thus reducing the risk of damage to the animal cage when the pin is sheared of.

The pin may be releasably attached to the animal cage such that it can be replaced, allowing the functionality of the pin to be restored even in the case that the animal cage has been subjected to a force being higher than the threshold value.

In a fifth aspect is an animal cage suitable for use for transportation of an animal in a vehicle provided. The animal cage comprising:
a bottom,
a top,
a frame assembly connecting the bottom to the top, the frame assembly comprising a front portion and a rear portion,
an access opening being provided in the front portion and/or the rear portion, and
an access door arranged in the access opening, the access door having an upper portion and a lower portion being individually moveable between an open position and a closed position in relation to the access opening, wherein the upper portion is configured to pivot around an upper pivot axis and the lower portion is configured to pivot around a lower pivot axis. Access to the animal cage through the access opening may thus be facilitated, the upper portion of the access door opening in an outwardly and upwardly direction while the lower portion of the access door opens in an outwardly and downwardly direction. Moreover, the upper portion and lower portion being individually moveable facilitates opening of the access door while reducing the risk of the animal kept therein escapes. The upper and lower portion may be connected and interlocked in the closed position. When opening the top portion, the bottom may still be closed, limiting the dogs exit, keeping it in control and contained. When the lower portion is opened it may create a platform that could be used when preparing the dog for an activity, e.g. putting on a reflective vest. Moreover, the access door having an upper and a lower portion facilitates use of the animal cage for instance when a trunk of the vehicle has a threshold at the trunk entry which would then still allow the upper portion of the animal cage to be opened.

The lower portion in the open position thereof may be configured to be arranged essentially parallel with the bottom of the animal cage, thus essentially forming a platform which extends the bottom of the animal cage facilitating extraction of the animal kept therein. For instance, the animal may be brought out of the animal cage and at least partially be arranged on the lower portion for instance for allowing the user to attach a leash on the animal.

The height of the lower portion may be essentially one third of a total height of the access opening.

The upper portion and/or the lower portion may be connected to the animal cage by means of a control member, the control member controlling the movement of the associated upper portion and/or lower portion between the open and closed position thereof.

The upper pivot axis and the lower pivot axis may be essentially perpendicular to a longitudinal direction of the animal cage.

In a sixth aspect is an animal cage suitable for use for transportation of an animal in a vehicle provided. The animal cage comprises:
a bottom,
a top,
a frame assembly comprising a connecting portion connecting the bottom to the top and a side member forming at least a portion of a side boundary of the animal cage.

The animal cage may be configured to be dimensionally stable in a use configuration as long as a force acting on the animal cage is lower than a predetermined force, and, when the force is higher than the predetermined force, to at least partially vary in shape through a relative movement, in particular a translatory and/or rotatory movement, of adjacent portions of the frame assembly, the bottom and/or the top with respect to each other.

With the above configuration, the animal cage can withstand higher forces since peak forces during an impulse occurring during a crash are reduced. The configuration allows a predefined movement when the predetermined force is exceeded. In this way, the forces from a crash can be absorbed gradually as adjacent portions of the frame assembly are allowed to perform a relative movement with respect to each other when a predetermined force is exceeded. Therefore, an elastic or plastic deformation in certain parts or at connecting portions of adjacent frame portions is prevented or at least reduced. In this way, it is prevented that frame portions may become detached.

The side member and the connecting portion may be coupled to each other to allow a defined relative movement between the side member and the connecting portion. Such an arrangement allows a defined movement and prevents deformation in the side member or the connecting portion.

The side member may be coupled to the connecting portion by means of a coupling arrangement configured to hold the side member spaced apart from and rotatable with respect to the connecting portion. In this way, the side member and the connecting portion may rotate with respect to each other if a predetermined threshold force or moment acting in the coupling arrangement exceeds a predetermined value. In this way, bending stress in the coupled members is reduced.

The side member may comprise a main extension direction. The side member may be coupled to the connecting portion such that an end surface portion of the side member faces the connecting portion in the main extension direction. The side member may thus be provided between connecting portions on longitudinal direction of the animal cage.

The coupling arrangement may comprise a holder with an attachment portion fixedly and non-moveably coupled to one of said connecting portion or the side member, and with a coupling portion pivotably coupled to the other one of the side member or the connecting portion about a pivot axis.

The side member may comprise a hollow end portion. The coupling portion may be accommodated in the hollow end portion of the side member.

In a direction cross to the main extension direction of the side member the coupling portion may comprise a cross dimension that is smaller than an inner cross dimension of the side member. In this way, a movement of the side member relative to the coupling portion about the pivot axis is facilitated.

The coupling portion may comprise a contact surface which is in contact with an inner surface of the side member. Contact between the contact surfaces creates static friction. The amount of static friction that needs to be overcome to allow a movement between the adjacent parts, in other words the stiction, may be preset by providing a defined surface roughness or material and by adjusting the contact pressure by which the surfaces are pressed against each other. For example, the side member may be coupled to the holder by a fastening means, for example a screw, bolt or rivet, urging the contact surfaces against each other and holding them together under maintenance of a defined urging force. The contact surface may be flat and/or may extend perpendicular to the pivot axis. The contact surface may fully extend about the pivot axis and/or may comprise a dimension in main extension direction of the side member which is larger than its dimension in a direction cross to the main extension direction of the side member. The coupling portion may be formed tapering towards the attachment portion.

The attachment portion may comprise a base portion extending along a main extension direction of the connecting portion and at least partially contacting an outer surface of the connecting portion.

The base portion may comprise at least one fixation section for attaching the holder to the connecting portion. At least one fixation section may comprise a hook portion hooked into an opening of the connecting portion. At least one fixation section may comprise a recess for receiving a coupling member.

The holder may comprise a stop portion configured to abut against an evacuation hatch of the animal cage. The stop portion may be provided on the holder to protrude beyond the connecting portion in a direction cross to the main extension direction of the connecting portion.

The holder including its different portions may be integrally formed. In some embodiments, the holder is integrally formed by cutting and bending a metal sheet.

The animal cage may further comprise a cover portion for covering a coupling section at which the side member is coupled with the connecting member. The cover portion may comprise a sleeve portion for receiving an end portion of the side member. The cover portion may comprise a fixation portion for attaching the cover portion on the side member. The cover portion may comprise a supporting portion configured to contact the connecting member. A main extension direction of the sleeve portion and a contact plane defined by the supporting portion may extend at an angle with respect to each other. In addition or alternatively, the cover portion may be configured to hold the side member at a predetermined orientation with respect to the connecting member and provides a predetermined resistance against the defined movement between the side member and the connecting portion to add rigidity to the frame assembly.

The connecting portion may be a front portion or a rear portion of the frame assembly. The side member may comprise a telescopic element. The front portion and the rear portion may be reciprocally moveable relative one another along a longitudinal direction of the animal cage such that a length of the animal cage may be adapted.

The animal cage may comprise at least one resistance altering element. The resistance altering element may have at least one pre-set force state for altering a longitudinal force required for relative movement of the front and rear portion. The animal cage may comprise a stop element configured to form a limit for the telescopic movement of the front portion and rear portion such that the front portion and the rear portion can at least normally not move past a first relative position. The stop element may be configured to allow relative movement of the front portion and the rear portion past the first relative position when the animal cage is subjected to a force in a longitudinal direction being higher than a threshold value.

The term use configuration can be understood as a configuration in which a relative movement is not possible during normal use of the animal cage. For example, a relative movement (translatory movement) in the side members comprising telescopic members is blocked when the resistance altering element is engaged. A relative movement (rotation) between the side members or the telescopic members and the front portion is normally blocked due to a tightening force provided by the screw connection and/or by the static friction in contact portions of movable parts and/or by a resistance against movement provided by the cover portion. In the compressed state of the animal cage, the stop element, for example a pin, may provide a limit for a movement between the front and rear portions but allows a relative movement beyond that limit when a certain force is exceeded (for example, when the stop element or pin is sheared of). As soon as an external force on the animal cage is high enough in longitudinal direction, the resistance provided by the resistance altering element and/or provided by the connection and/or by the stop element and/or by the cover portion will be overcome and a relative movement will take place.

### BRIEF DESCRIPTION OF THE DRAWINGS

With reference to the appended drawings, below follows a more detailed description of embodiments of the invention cited as examples.

In the drawings:

FIG. 1 discloses a front perspective view of an animal cage.

FIG. 2 discloses a side view of a an animal cage in a compressed state.

FIG. 3 discloses a detail cross-sectioned view of the longitudinal bottom track and bottom track member.

FIG. 4 discloses a detail cross-sectioned view of the longitudinal top track and top track member.

FIG. 5 discloses a side view of an animal cage in an expanded state.

FIG. 6 discloses a detail view of a resistance altering element in a high force state.

FIG. 7 discloses a detail view of a resistance altering element between a high force state and a low force state.

FIG. 8 discloses a detail view of a resistance altering element in a low force state.

FIG. 9 discloses a detail perspective view of a resistance altering element of an animal cage.

FIG. 10 discloses a detail front view of a resistance altering element of an animal cage.

FIG. 11 discloses a detail side view of a resistance altering element of an animal cage.

FIG. 12 discloses a bottom view of an animal cage.

FIG. 13 discloses a detail view of a stop element of an animal cage.

FIG. 14 discloses a perspective view of an animal cage with an access door in an open position.

FIG. 15 discloses a bottom cross-sectioned view of an animal cage with an access door in an open position.

FIG. 16 discloses a side view of an animal cage with an access door in an open position.

FIG. 17 discloses a cross-sectioned side view of an animal cage with an access door in a closed position.

FIG. 18 discloses a bottom cross-sectioned view of an animal cage with an access door in a closed position.

FIG. 19 discloses a rear view of an evacuation hatch of an animal cage.

FIG. 20 discloses a front view of an evacuation hatch of an animal cage.

FIG. 21 discloses a cross-sectioned perspective view of an opened evacuation hatch of an animal cage.

FIG. 22 discloses a perspective view of an animal cage having an access door comprising an upper portion and a lower portion.

FIG. 23 discloses a perspective view of a rear portion of an animal cage.

FIG. 24 discloses a side view of a coupling arrangement of an animal cage.

FIG. 25 shows a sectional view of the coupling arrangement of FIG. 24.

FIG. 26 shows a side view of the coupling arrangement of FIG. 25 as seen from the opposite side.

FIG. 27 discloses a perspective view of components of the coupling arrangement.

FIG. 28 discloses a side view of a holder of a coupling arrangement.

FIG. 29 discloses a perspective view of a coupling arrangement provided on an end portion of a side member and partially covered by a cover portion.

FIG. 30 discloses a perspective view of the cover portion of FIG. 29.

The drawings show diagrammatic exemplifying embodiments of the present invention and are thus not necessarily drawn to scale. It shall be understood that the embodiments shown and described are exemplifying and that the invention is not limited to these embodiments. It shall also be noted that some details in the drawings may be exaggerated in order to better describe and illustrate the invention. Like reference characters refer to like elements throughout the description, unless expressed otherwise.

### DETAILED DESCRIPTION

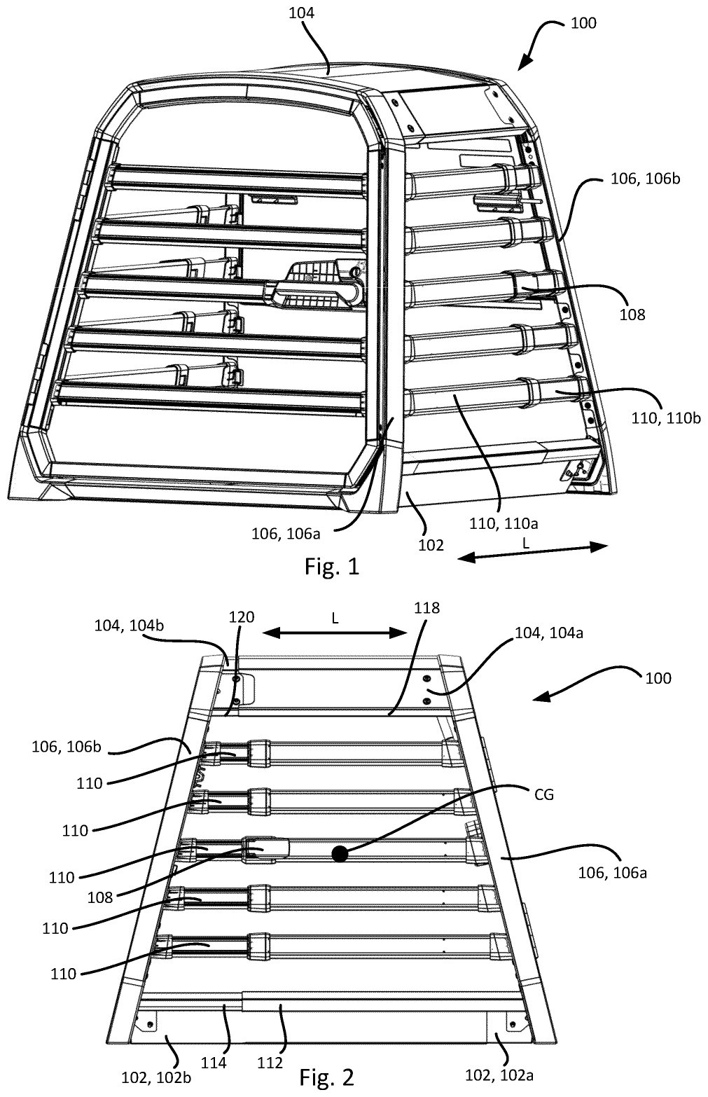

FIG. 1 shows a front perspective view of an animal cage 100. The animal cage 100 is suitable for transporting and keeping animals, preferably dogs but it is naturally suited for other animals as well. The animal cage 100 is ideally used for keeping the animal in a confined space during transportation in or on a vehicle, such as in the trunk of a car. As such, the animal cage 100 provides a confinement for the animal within the vehicle and prevents it from moving around which is not desired as it could cause a distraction and danger during driving.

The animal cage comprises a bottom 102 and a top 104. The bottom 102 forms the structure in the animal cage 100 on which the animal rests as it is kept in the cage. The bottom 102 may be provided with a carpet/cover for instance in the form of a silicone or rubber mat. The bottom 102 may be formed by a suitable material such as a polymeric, a metallic or a composite material. The bottom 102 may further be provided with openings and/or slots (not shown) for instance for permitting improved ventilation and for allowing the animal to see better out of the cage.

The top 104 of the animal cage 100 forms an upper restriction for the animal kept in the cage 100. The top 104 may be formed by a suitable material such as a polymeric, a metallic or a composite material. The top 104 may further be provided with openings and/or slots (not shown) for instance for permitting improved ventilation and for allowing the animal to see better out of the cage.

The animal cage 100 further comprises a frame assembly 106 connecting the bottom 102 to the top 104. The frame assembly 106 comprises a front portion 106a and a rear portion 106b. The front portion 106a and the rear portion 106b may be reciprocally moveable relative one another along a longitudinal direction L of the animal cage 100 such that a length of the animal cage 100 may be adapted. Length in the present disclosure is thus defined as measured along the longitudinal direction L. The animal cage 100 further comprises at least one resistance altering element 108 having at least one pre-set force state for altering a longitudinal force required for relative movement of the front 106a and rear portion 106b. A longitudinal force is to be interpreted as a force acting on the animal cage 100 in the longitudinal direction L or longitudinally directed component of a force acting on the animal cage, the force may be in the forward or rearward direction. A forward acting force is to be interpreted as a force acting in the longitudinal direction L and in the direction from the front portion 106a towards the rear portion 106b. A rearward acting force act oppositely is to be considered as acting in the longitudinal direction L and in the direction from the rear portion 106b towards the front portion 106a.

The animal cage 100 is intended to be arranged in a vehicle such that the longitudinal direction L is arranged along the travelling direction of the vehicle. It is however possible to arrange the animal cage 100 in other orientations as well. Regardless of the orientation of the animal cage 100, the cage 100 is by the reciprocal relative movement of the front and rear portion 106a, 106b capable of absorbing a force while reducing the risk of the animal cage 100 being damaged. Additionally, the resistance altering element 108 facilitates use of the animal cage 100 as the resistance can for instance be lowered to allow telescoping of the animal cage 100 for adaptation of the size of the animal cage 100 to the animal and/or to fit into the vehicle. The animal cage 100 can thus be adapted to suit a larger variety of animals and also be fitted into more vehicles.

The animal cage 100 may as is shown in FIG. 1 be provided with a plurality of telescopic elements 110 which forms the side enclosure of the animal cage 100. A plurality of telescopic elements 110 may be provided on both lateral sides of the animal cage 100. The space between two adjacent telescopic elements 110 may be less than 10 cm, preferably less than 5 cm, thus preventing that the animal can escape from the animal cage 100. The space, i.e. the distance, between two adjacent telescopic elements 110 may be between 2 cm and 6 cm, between 3 cm and 5 cm and in one embodiment approximately 4 cm.

Each telescopic element 110 extends between the front portion 106a and the rear portion 106b of the frame arrangement 106 and functions as both a side enclosure of the animal cage 100 as well as a guide for the relative movement of the front portion 106a and rear portion 106b. Each telescopic element 110 may comprise a front telescopic portion 110a and a rear telescopic portion 110b being configured to be reciprocally moveable with the front and rear portion 106a, 106b respectively and telescopically engaged with each other. The front telescopic portion 110a being connected to the front portion 106a and the rear telescopic portion 110b being connected to the rear portion 106b. Preferably, the rear telescopic portion 110b in each telescopic element 110 is arranged partially interiorly of the front telescopic portion 110a, but the opposite relationship is also possible. The telescopic elements 110 as mentioned may form a guide for the telescopic movement of the animal cage 100.

In FIG. 2 is the animal cage 100 shown in a left side view in a compressed state, i.e. when the front portion 106a and the rear portion 106b are as close as possible to each other. As is illustrated in FIG. 2, the resistance altering element 108 may be arranged on a telescopic element 110. Naturally, more than one telescopic element 110 may be provided with a resistance altering element 108. A telescopic element 110 on each lateral side of the animal cage 100 may be provided with a resistance altering element 108, thus facilitating that both lateral sides of the are held in position with the equal force and that telescopic movement is even on both lateral sides of the animal cage 100.

Moreover, the bottom 102 of the animal cage 100 may comprise a front bottom portion 102a and a rear bottom portion 102b being configured to be reciprocally moveable with the front and rear portion 106a, 105b respectively and telescopically engaged with each other. The front bottom portion 102a being connected to the front portion 106a and the rear bottom portion 102b being connected to the rear portion 106b.

The front bottom portion 102b may at each lateral side thereof comprise a longitudinal bottom track 112 in which a corresponding bottom track member 114 on the rear bottom portion 102b is configured to be arranged and slide. In such an embodiment, the rear bottom portion 102b is preferably configured to be arranged at least partially underneath the front bottom portion 102a. While the foregoing is preferred, it is naturally however also possible to have the opposite arrangement, with the longitudinal bottom track 112 being arranged in the rear bottom portion 102b, the bottom track member 114 in the front portion 106a and the front bottom portion 102a being arranged at least partially underneath the rear bottom portion 102b.

The telescopic element 110 provided with the resistance altering element 108 may be arranged at a height from the bottom 102 of the animal cage 100 in the proximity of a corresponding height from the bottom 102 of the animal cage 100 of a center of gravity CG of said animal cage 100. The longitudinal force from one half of the animal cage 100 for instance from an impact may thus be transmitted essentially in the direction and along the extension of telescopic element 110 comprising the resistance altering element 108, thus facilitating reliable telescopic function.

The telescopic element 110 provided with the resistance altering element 108 may be arranged at a height from the bottom 102 of the animal cage 100 that is essentially half of a total height of the animal cage 100.

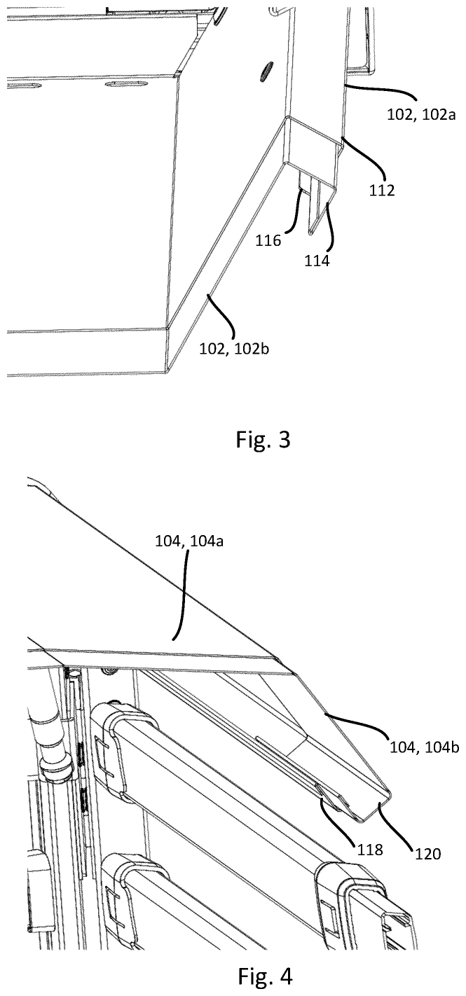

FIG. 3 discloses a detail cross-sectioned view of the longitudinal bottom track 112 and the bottom track member 114. Preferably, the longitudinal bottom track 112 is formed by a plurality of folds in the front bottom portion 102a. The bottom track 112 may be formed by at least three folds such that a lip 116 is formed extending along the length of the bottom track 112, the lip 116 being configured to hold the bottom track member 114 in the bottom track and prevent unintentional separation of the longitudinal bottom track 112 and bottom track member 114. Preferably, the longitudinal bottom track 112 is configured such that the bottom track member 114 can only be connected/disconnected from the longitudinal bottom track 112 by a movement in the longitudinal direction L. Each fold may be essentially 90°.

The bottom track member 114 is preferably formed by a plurality of folds in the rear bottom portion 102b, such that the bottom track member 114 can fit inside the longitudinal bottom track 112. Preferably the bottom track member 114 is formed by at least two folds. Each fold may be essentially 90°.

Moreover, the top 104 of the animal cage 100 may comprise a front top portion 104a and a rear top portion 104b being configured to be reciprocally moveable with the front and rear portion 106a, 106b respectively and telescopically engaged with each other. The front top portion 104a being connected to the front portion 106a and the rear top portion 104b being connected to the rear portion 106b.

Returning to FIG. 2, the front top portion 104b may at each lateral side thereof comprise a longitudinal top track 118 in which a corresponding top track member 120 on the rear top portion 104b is configured to run. In such an embodiment, the rear top portion 104b is preferably configured to be arranged at least partially underneath the front top portion 104a. While the foregoing is preferred, it is naturally however also possible to have the opposite arrangement, with the longitudinal top track 118 being arranged in the rear top portion 104b, the top track member 120 in the front top portion 104a and the front top portion 104a being arranged at least partially above the rear top portion 104b.

FIG. 4 discloses a detail cross-sectioned view of the longitudinal top track 118 and the top track member 120. Preferably, the longitudinal top track 118 is formed by a plurality of folds in the front top portion 104a. The longitudinal top track 118 may be formed by at least two folds in the front top portion 104a, thus providing a stable structure for the top track member 120 to slide in and to prevent unintentional separation of the longitudinal top track 118 and the top track member 120. Preferably, the longitudinal top track 118 is configured such that the top track member 120 can only be connected/disconnected from the longitudinal top track 118 by a movement in the longitudinal direction L. Each fold may be essentially 90°.

The top track member 120 is preferably formed by a plurality of folds in the rear top portion 104b, such that the top track member 120 can fit inside the longitudinal top track 118. Preferably the top track member 120 is formed by at least two folds. Each fold may be essentially 90°.

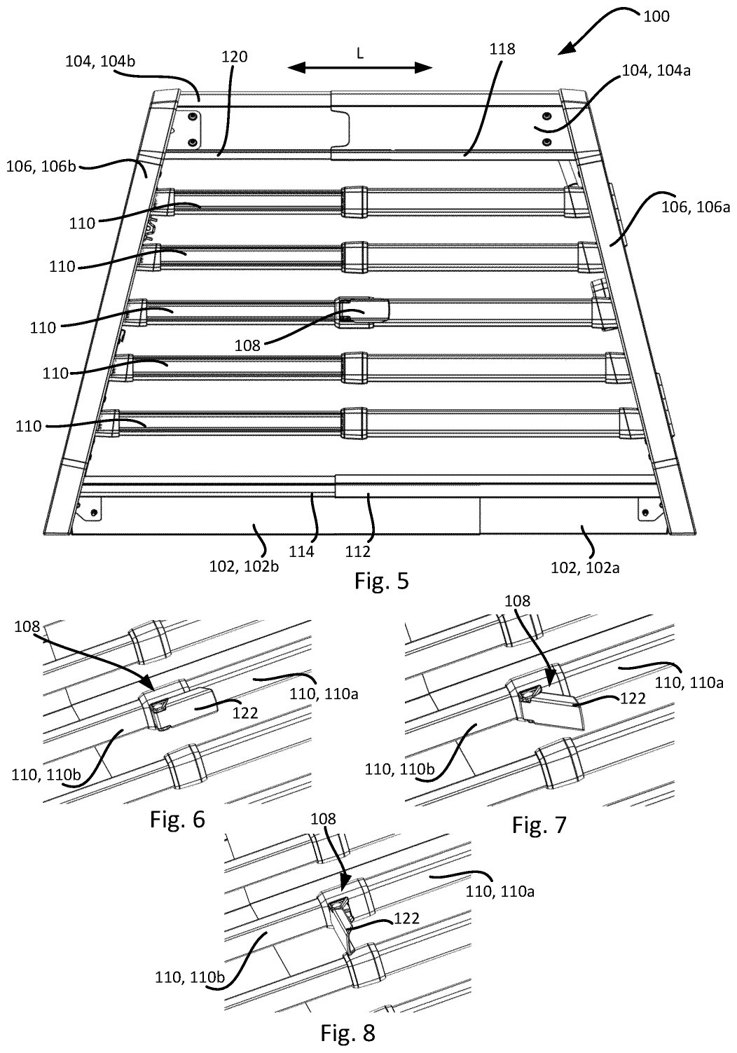

FIG. 5 shows the animal cage 100 from a left side view in an expanded state, i.e. in which the front portion 106a and rear portion 106b have been moved away from each other in the longitudinal direction L such that the length of the animal cage 100 is longer than that of the animal cage 100 shown in FIG. 1. It is to be realized that the front portion 106a and rear portion 106b of the animal cage 100 may be arranged in any relative position between a max expanded state as shown in FIG. 5 and the compressed state shown in FIG. 1.

The left and right lateral side of the animal cage 100 may in all embodiments disclosed herein be identical.

FIGS. 6 to 8 discloses detail views of a resistance altering element 108 as it is moved between a high force state, shown in FIG. 6 and a low force state, shown in FIG. 8. I.e. between two pre-set force states. As mentioned, the animal cage 100 may be provided with more than one resistance altering element 108. In the high force state is the longitudinal force, i.e. a force acting on the animal cage 100 in the longitudinal direction L, required for relative movement of the front portion 106a and the rear portion 106b high.

The resistance altering element 108 shown in FIG. 6 is as mentioned set in the high force state. The resistance altering element 108 may as is shown in FIGS. 6 to 8 comprise a clamp mechanism 122. The clamp mechanism 122 being actuatable by a user to switch the resistance altering element 108 between the high force state and the low force state. The clamp mechanism 122 may thus be configured to be set in a clamping state, corresponding to the high force state of the resistance altering element 108 and a released state corresponding to the low force state of the resistance altering element 108.

Preferably, when the resistance altering element 108, specifically the clamp mechanism 122 thereof, is set in the low force state, i.e. in the released state, the length of the animal cage 100 in the longitudinal direction L can be easily adjusted by pushing on either the front portion 106a and/or the rear portion 106b of the cage 100.

When the resistance altering element 108, or specifically the clamp mechanism 122 thereof, is set in the high force state, i.e. in the clamping state, a predetermined force in the longitudinal direction must be overcome to achieve relative movement of the front portion 106a and the rear portion 106b. The longitudinal force required for achieving relative movement of the front and rear portion in the high force state may in an embodiment correspond to at least half of a total weight of the animal cage. The longitudinal force that each resistance altering element 108 needs to withstand is thus equal to the total longitudinal force divided by the number of resistance altering elements 108 provided to the animal cage 100.

The longitudinal force required for achieving relative movement of the front and rear portion in the high force state may be between 50 N and 200 N depending on the weight of the animal cage 100, which may vary depending on if the animal cage 100 is manufactured for a large or small animal.

By providing a resistance altering element 108 as described in the foregoing, the animal cage 100 can be adjusted in size as desired by a user without risking that the telescopic function and safety of the animal cage 100 is compromised. When the desired size is achieved, the user places the resistance altering element 108 in the high force state whereby the intended functionality and safety of the animal cage 100 can be provided in case of an accident. The provision of the resistance altering element 108 having a high force and low force state reduces the risk of the telescoping function not working as intended and thus increases the safety and ease of use of the animal cage 100. These functionalities may be even further improved by embodiments and features described in following.

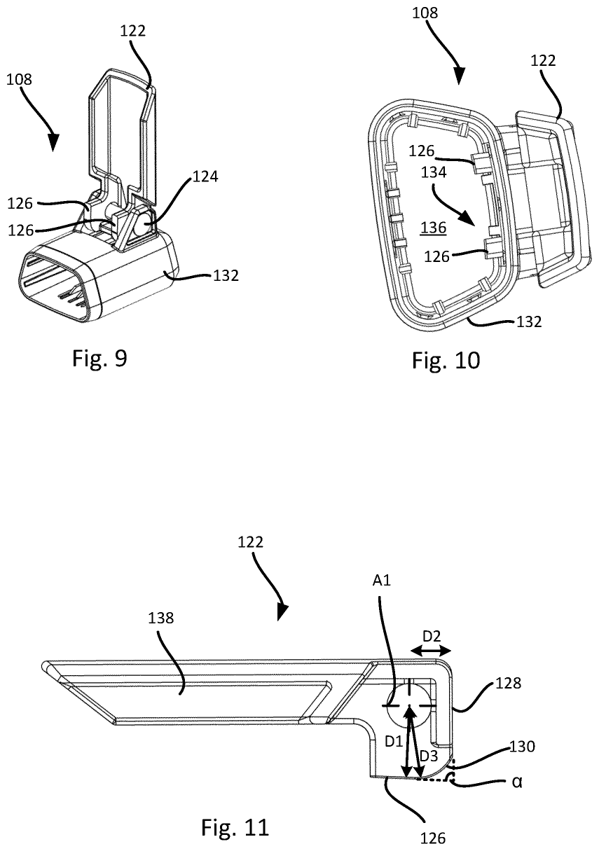

FIG. 9 discloses a perspective detail view of a resistance altering element 108 in the low force state. As shown, each resistance altering element 108 may comprise a base portion 132 being configured to be arranged on a telescopic element 110. The base portion 132 forms a support for a clamping mechanism 122 which may be attached to the base portion by means of a rotation pin 124 forming a rotation axis A1 (shown in FIG. 11) around which the clamping mechanism 122 can rotate to set the resistance altering element 108 in the high force state and the low force state respectively.

The base portion 132 is preferably attached to the front telescopic portion 110a of the associated telescopic element 110.

As is illustrated in FIG. 10, the clamp mechanism 122 is configured to alter a pressure applied to an interface 134 for controlling an induced friction force thus altering the longitudinal force required for relative movement of the front portion 106a and the rear portion 106b. The interface 134 is to be interpreted as the contact area between the clamp mechanism 122 and the associated telescopic element 110. In FIG. 10, the telescopic element 110 is omitted for clarity, it is however illustrated how the clamping mechanism 122 and specifically a first cam surface 126 thereof protrudes into a space 136 in the base portion 132 through which the telescopic element 110 extends thus generating a force against a telescopic element 110 arranged in the space 136.

The resistance altering element 108 is arranged with the base portion 122 on either the front telescopic portion 110a or the rear telescopic portion and such that the clamping mechanism 122 can induce a force on the one of the front telescopic portion 110a and the rear telescopic portion 110b on which the base portion 132 is not arranged. A friction force can thus be attained between the front telescopic portion 110a and the rear telescopic portion 110b.

FIG. 11 show a side view of a clamping mechanism 122. The clamping mechanism 122 may be provided with a lever portion 138 which the user can move between a clamping state, corresponding to the high force state of the resistance altering element 108, and a released state, corresponding to the low force state of the resistance altering element 108, of the clamping mechanism 122. In the high force state, the lever portion 138 may be arranged adjacent to and/or abutting against the base portion 132 thus forming a predetermined position and force between the resistance altering element 108 and the telescopic element 110.

As is illustrated, the clamp mechanism 122 may comprise a first cam surface 126. The first cam surface 126 is preferably arranged at a first distance D1 as measured perpendicularly from the first cam surface 126 to the rotation axis A1 around which the clamp mechanism is configured to rotate. The distance D1 is larger than the corresponding distance between the rotation axis A1 and the telescopic element 110, thus ensuring that the clamp mechanism 122 applies a pressure on the telescopic element 110 when in the clamping state, i.e. in the high force state of the resistance altering element 108. The first cam surface 126 may be a flat surface as illustrated in FIG. 11, however it could also be curved or have another shape as well.

A release surface 128 may further be provided being arranged at an angle α in relation to the first cam surface 126. The release surface 128 being arranged at a second distance D2 from the rotation axis A1 as measured perpendicularly from the release surface 128. The second distance D2 being less than the first distance D1. The second distance D2 is preferably equal to or less than a corresponding distance from the rotational axis A1 to the associated telescopic element 110, thus ensuring that only little or no pressure is provided by the cam mechanism 122 to the telescopic element 110 in the released state i.e. in the low force state of the resistance altering element 108. The angle A between the first cam surface 126 and the release surface 128 may be less than 90°, however other angles A are naturally also possible. The angle A defines the amount of rotation of the clamp mechanism 122 that is needed to move it between the clamping state, i.e. the high force state of the resistance altering element 108, and the released state, i.e. the low force state of the resistance altering element 108.

A second cam surface 130 may further be provided, the second cam surface 130 being curved and arranged at a third distance D3 from the rotation axis A1, the distance D3 being defined as the largest distance from the second cam surface 130 to the rotation axis A1. The second cam surface 130 forms a transition between the first cam surface 126 and the release surface 128. The third distance D3 may be equal to or more than the first distance D1, thus providing a knuckle that the clamp mechanism 122 has to be rotated past to get from the clamping state to the released state or vice versa. The clamp mechanism 122 can thus be locked in the clamping state, i.e. in the high force state of the resistance altering element 108, and/or in the released state, i.e. in the low force state of the resistance altering element 108.

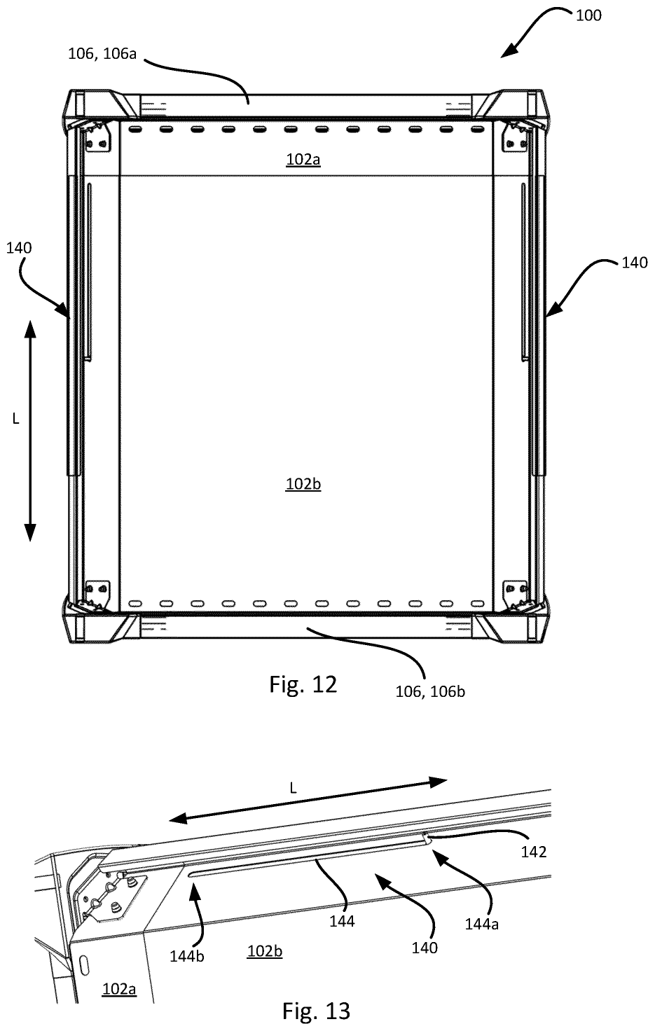

In FIG. 12 is the animal cage 100 shown in a compressed state and from a bottom view. The embodiment shown in FIG. 12 is combinable with all other embodiments disclosed herein. The animal cage 100 in FIG. 12 comprises a stop element 140 being configured to form a limit for the telescopic movement of the front 106a and rear portion 106b such that the front portion 106a and rear portion 106b cannot move past a first relative position. The first relative position may as is shown in FIG. 12 be the compressed position of the animal cage which defines the closest relative position of the front portion 106a and the rear portion 106b during regular use of the animal cage 100. The stop element 140 is further configured to allow relative movement of the front portion 106a and rear portion 106b past the first relative position when the animal cage 100 is subjected to a force in the longitudinal direction L being higher than a threshold value, for instance in the case of an accident.

As is illustrated in FIG. 12, a respective stop element 140 may be provided on each lateral side of the animal cage 100. While in FIG. 12 the stop element 140 is shown being arranged in the bottom 102 of the animal cage 100, it may also or alternatively be provided in the top 104.

Moreover, a stop element 140 may alternatively or in addition be provided in a front telescopic portion 110a and/or rear telescopic portion 110b in at least one of the at least one telescopic element 110 such that movement of the front portion 106a and the rear portion 106b past the first relative position is only possible when the animal cage 100 is subjected to a force in the longitudinal direction being higher than the threshold value.

FIG. 13 discloses a detail view of a stop element 140, which as mentioned could be provided in one or more of the bottom 102, top 104 and one or more of the telescopic elements 110.

Each stop element 140 may comprise at least one pin 142 being configured to be sheared of by telescopic movement between the front portion 106a and rear portion 106b in case the animal cage 100 is subjected to a force in the longitudinal direction L being higher than the threshold value.

The pin 142 may be configured to cooperate with a slot 144 such that the extension of the slot 144 defines the first position and such that the pin 142 is configured to be sheared by engagement with an end 144a of the slot. The slot 144 further comprises a second end 144b defining a second position, where the front portion 106a and rear portion 160b of the animal cage 100 are arranged as far apart as possible in the longitudinal direction L as illustrated in FIG. 5. As such, the pin 142 may be configured to shear to allow the animal cage 100 to expand past the second position as well. Additionally, the cooperation of the groove 144 and the pin 142 in each stop element 140 provides additional guiding of the reciprocal movement of the front portion 106a and the rear portion 106b of the animal cage 100.

The threshold longitudinal force acting on the animal cage 100 required for shearing the pin 142 in all stop elements 140 provided on the animal cage 100 may correspond to half of the weight of the animal cage 100. The threshold longitudinal force acting on the animal cage 100 required for shearing the pin 142 in all stop elements 140 may be between 50 N and 200 N.

The threshold longitudinal force required for shearing the pin 142 in all stop elements 140 may in one embodiment be less than the longitudinal force required for achieving relative movement of the first and rear portion 106a, 106b in the high force state of the resistance altering element 108, thus ensuring that the resistance altering element 108 controlling the maximum longitudinal force required for reciprocal relative movement of the front and rear portion 106a, 106b.

The threshold longitudinal force acting on the animal cage 100 required for shearing the pin 142 in all stop elements 140 may in one embodiment be higher than the longitudinal force required for relative movement of the first and rear portion 106a, 106b when the resistance altering element 108 is in the low force state. It may thus be prevented that the pin 142 is sheared by accident by a user adjusting the size of the animal cage 100.

The pin 142 in each stop element 140 may be configured to be sheared before plastic deformation is achieved in the slot 144, thus reducing the risk of damage to the animal cage 100 in case of shearing of the pin 142.

The pin 142 in each stop element 140 may further be releasably attached to the animal cage 100 such that it can be replaced once it has been sheared or otherwise has been damaged.

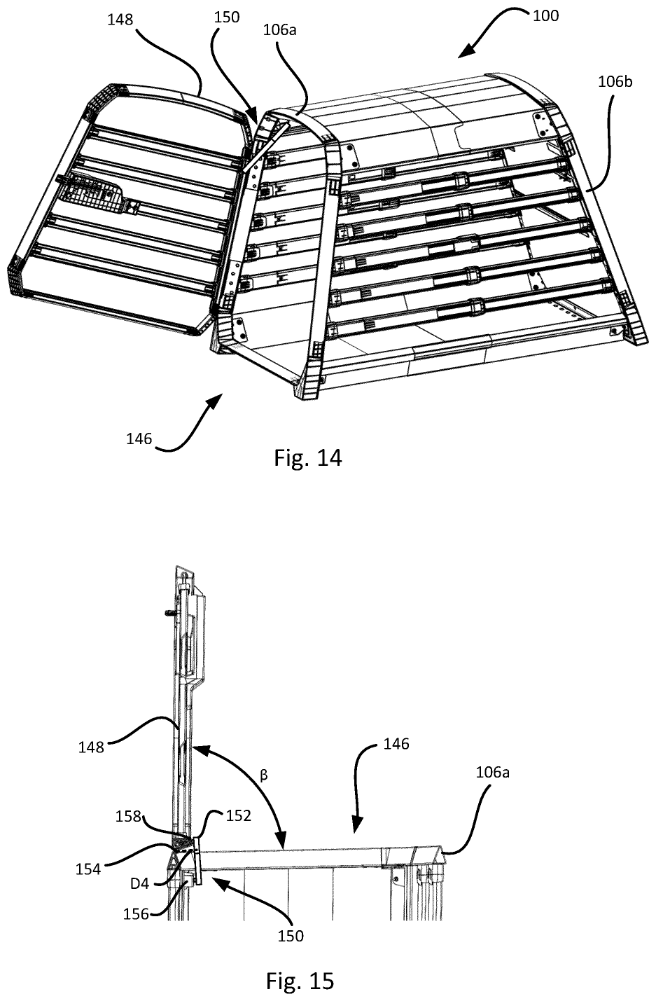

FIG. 14 discloses perspective view of the animal cage 100. The animal cage 100 is illustrated as a telescoping animal cage 100 as described in the foregoing and is as such applicable to the foregoing embodiments, but the teachings below are equally applicable to another type of animal cage 100 as well, for instance one without a front and rear portion 106a, 106b which are moveable in relation to one another.

As illustrated, the animal cage 100 in FIG. 14 comprises a cage access opening 146 at least in the front portion 106a of the animal cage 100. It is to be realized that an access opening 146 may also be provided in the rear portion 106b of the animal cage 100.

The cage access opening 146 is formed in the front portion 106a of the frame arrangement 106. The animal cage 100 further comprising an access door 148 arranged in the access opening 146 and being pivotable in relation to the front portion 106a. The animal cage 100 further comprises an access door motion control mechanism 150 being configured to provide a moment of force, i.e. a rotational force or torque, that varies with the opening angle β (shown in FIG. 15) of the access door 148.

In FIG. 15, the animal cage 100 is shown in a bottom cross-sectioned view. The motion control mechanism 150 may comprise a so called constant force spring 152, providing an essentially constant force in the axial direction of the constant force spring 152 applied between the animal cage 100 and the access opening door 148 regardless of the axial length of the constant force spring 152. The constant force spring 152 in the present disclosure is configured to provide a pushing force acting on the access door 148. The constant force spring 152 may be a gas spring, providing an axial force that only varies to a small extent as a function of a change in the axial length thereof. Another type of spring is also considered however, the teachings herein are not limited to only constant force springs as defined in the foregoing but other types of actuating elements may also be used. It is further to be realized that the constant force spring 152 may be configured to provide a damping effect, for instance to prevent that the movement of the access door 148 is too fast.

The constant force spring 152 is configured to increase the moment of force provided to the access door 148 in the opening direction with increasing opening angle β of the access door 148. This may be achieved by the relative position of a first motion control mechanism attachment 156 and a second motion control mechanism attachment 158 changing in accordance with the opening angle β of the access door 148. The first motion control mechanism attachment 156 being arranged on the frame assembly 106 and/or on the top 102 of the animal cage 100. The second motion control mechanism attachment 158 being arranged on the access opening door 148. The motion control mechanism 150, specifically the constant force spring 152 thereof, extends between the first and second motion control mechanism attachments 156, 158.

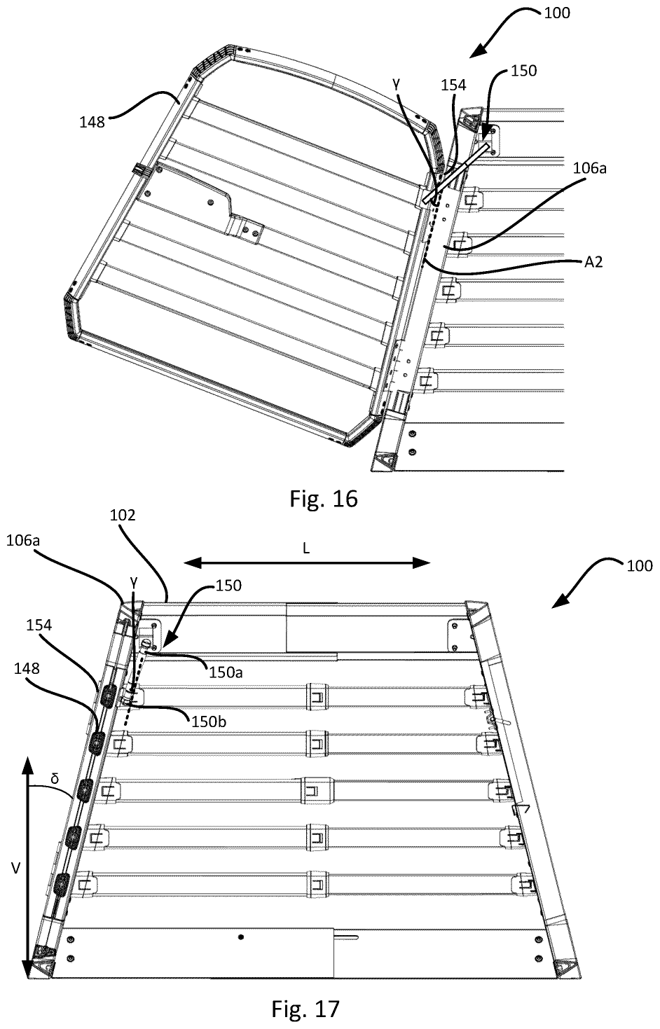

The rotational moment of force generated by the access door motion control mechanism 150 acting on the access door 148 may be considered as the outwardly directed component of the total axial force provided by the motion control mechanism 150 times a lever arm distance D4, D4 being defined as the distance measured perpendicularly from the axial direction of the motion control mechanism 150 to the hinge 154. Outwardly directed in the present disclosure is to be interpreted as the component of the axial force of the motion control mechanism 150, or the constant force spring 152 thereof, directed perpendicularly in relation to the rotational axis of the hinge 154 as observed from the side as in FIG. 16. Preferably, the rotational axis of the hinge 154 is parallel with the plane of the front portion 106a of the frame assembly 106. The lever arm distance D4 between the hinge 154 of the access door 148 and the axial direction of the motion control mechanism 150 may increase with increased opening angle at least between 0° and 90° opening angle thereof.

As is further illustrated in FIG. 16 which shows a cross-sectioned side view of the animal cage 100 with the access door 148 open, the outwardly directed force component of the total axial force of the motion control mechanism 150 may be estimated as the total axial force*sin γ, where the angle γ is the angle between the rotational axis A2 of the hinge 154 as observed from the side (specifically the orientation of the axis around which the hinge 154 rotates) and the axial direction of the motion control mechanism 150. As mentioned, the rotational axis A2 of the hinge 154 is preferably parallel with the plane of the first portion 106, the angle γ may thus also correspond to the angle between the plane of the first portion 106a and the axial direction of the motion control mechanism 150.

FIG. 17 discloses a cross-sectioned side view of the animal cage 100 with the access door 154 closed. As illustrated in FIG. 17, the angle γ when the access door 148 is closed is significantly less than when the door 148 is open as in FIG. 16. The rotational moment of force will thus increase during the opening of the access door 148.

As is further illustrated in FIG. 17 the hinge 154 of the access door 148 is arranged at an angle δ in relation to a vertical direction V such that the access door 148 in opening angles less than 90° is biased into the closed position. The angle δ may be between 5° and 30°, in one embodiment between 10° and 20°. The access door 148 is thus biased by the weight thereof into the closed position at opening angles less than 90°, with an increasing closing moment of force as the access door 148 nears the closed position. The combination of the inclined arrangement of the access door 148 and the motion control mechanism 150 which gradually decreases its opening moment of force on the access door 148 as it closes provides a self-closing effect where the access door 148 can be let go of in order to let it self-close, while the motion control mechanism 150 overcomes the closing moment of force from the weight of the access door 148 at larger opening angles such that the access door 148 is opened and held open. The motion control mechanism 150 may be configured to overcome the weight of the access door 148 at opening angles β being larger than 20° as measured from the closed position of the access door 148.

One or both ends 150a, 150b of the constant force spring 152 may be attached to the animal cage by means of a ball joint. I.e. the interface between the first motion control mechanism attachment 156 and/or the second motion control mechanism attachment 158 respectively and the constant force spring 152 may be formed by a ball joint.

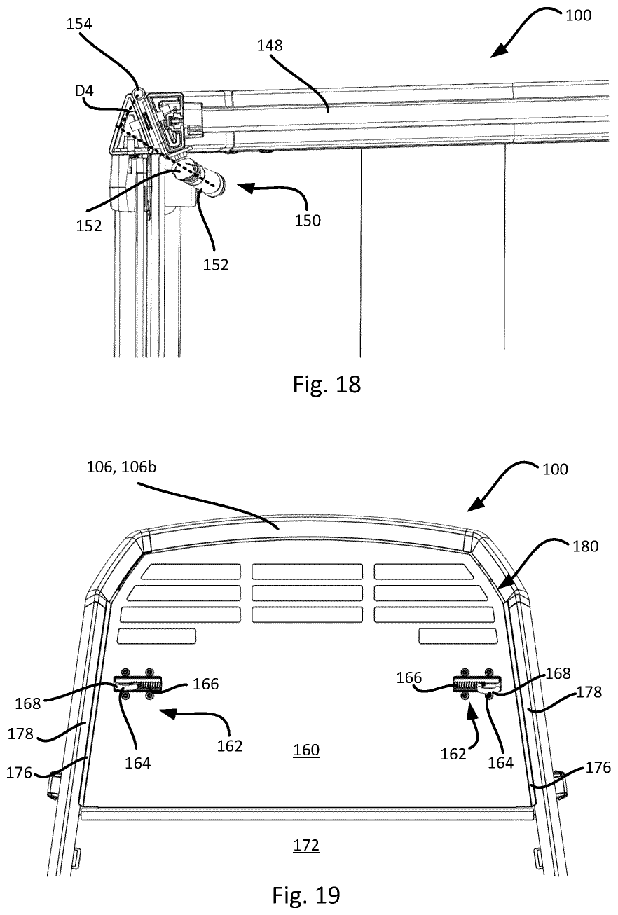

In FIG. 18 is a bottom cross-sectioned view of the animal cage 100 with the access door 148 closed shown. As mentioned in the foregoing, the lever arm distance D4 between the hinge 154 of the access door and the axial direction, illustrated by the dotted line in FIG. 18, of the motion control mechanism 150 increases with increased opening angle β of the access door 148 at least between 0° and 90° opening angle β thereof. In the present disclosure, the lever arm distance D4 is to be considered positive if it contributes to an opening moment of force on the access door 148.

Further Illustrated in FIG. 18 is that the lever arm distance D4 may be such that the motion control mechanism 150 provides a closing moment of force in a closed position of the access door 148. The orientation of the motion control mechanism 150, preferably the constant force spring 152 thereof, may be configured to change during the movement of the door 148 such that the lever arm distance D4 turns from positive to negative at an opening angle β of the access door 148 between 0° and 45°. As realized by the formula in discussed in the foregoing, a negative lever arm distance D4 provides a closing moment of force acting on the access door 148 by the motion control mechanism 150. Accordingly, the motion control mechanism 150 may facilitate closing of the access door 148.

Further illustrated in FIG. 18 is that the hinge 154 may be arranged on an opposite side of the access door 148 in relation to the second motion control mechanism attachment 158, thus forming semicircular movement of the second motion control mechanism attachment 158 around the rotational axis of the hinge 154 which defines the axial direction of the motion control mechanism 150.

As such, the moment of force on the access control door 148 provided by the motion control mechanism 150 may be defined as a function of the position of the second motion control mechanism attachment 158 in relation to the hinge 154, where the second motion control mechanism attachment 158 movement is defined by the opening angle of the access door 148 and moves therewith along a radius as measured between the second motion control mechanism attachment 158 and the hinge 154.

In FIG. 19 is a rear view of an animal cage 100 shown. The animal cage may be considered as a telescoping animal cage 100 as described in the foregoing and is as such applicable to the foregoing embodiments, but the teachings below are equally applicable to another type of animal cage 100 as well, for instance one without a front and rear portion 106a, 106b which are moveable in relation to one another.

As illustrated in FIG. 19, the animal cage 100 comprises at least one animal evacuation hatch 160 configured to allow extraction of the animal kept in the cage 100 in case of emergency, the animal evacuation hatch 160 comprising a latching arrangement 162 being configured to secure the evacuation hatch 160 in relation to the frame assembly 106 such that the evacuation hatch 106 can be locked in place automatically by the latching arrangement 162 when brought into a predetermined position in relation to the frame assembly 106. Automatically in the present disclosure is to be interpreted as that the latching arrangement 162 is arranged in the locked position and held there without the user having to manually tighten or manipulate the latching arrangement 160 once the evacuation hatch 160 is in the predetermined position. Preferably, the predetermined position is the closed position in relation to the animal cage 100 as illustrated in FIG. 19. The evacuation hatch 160 is preferably made from a metallic material such as aluminum or steel, however it may just as well be manufactured from a polymer material or composite material.

The evacuation hatch 160 may be arranged in the rear portion 106b of the animal cage 100 as shown, but naturally can other positions of the evacuation hatch 160 also be considered part of the disclosure. The evacuation hatch 160 is preferably removeable such that an evacuation opening 180 is made accessible to a user for evacuation of an animal in the cage 100.

A latching arrangement 162 may be provided at least at each lateral side of the evacuation hatch 160. Naturally, a latching arrangement 162 may also or alternatively be arranged on the upper part or lower part of the evacuation hatch 160.

Each latching arrangement comprises a respective latching pin 164. Each latching pin 164 may be provided with a handle 168 such that it can be manipulated and moved by a user from an extended (i.e. locked) position, as shown in FIG. 19, to a retracted (i.e. unlocked) position as shown in FIG. 21 where the evacuation hatch 160 can be moved out of the predetermined closed position.

Each latching pin 164 may be biased into the extended position in which the evacuation hatch 160 is locked in place. Each latching arrangement 150 may thus comprise a spring 166, providing a biasing force to the associated latching pin 164 into the extended position.

The evacuation hatch 160 may comprise a lateral flange 176 arranged on each lateral side of the evacuation hatch 160. Each lateral flange 176 extending at an angle in relation to the remainder of the evacuation hatch 160 such that the two lateral flanges 176 together may form a stop for a movement of the evacuation hatch 160 in the longitudinal direction L towards the front portion 106a of the animal cage 100. The total width of the evacuation hatch 160 including the lateral flanges 176 may thus be larger than a corresponding width of the evacuation opening 180.

The rear portion 106b may comprise laterally opposite abutment surfaces 178 being inclined such that a horizontal distance, i.e. the width of the evacuation opening 180, between the opposite abutment surfaces 178 decreases in the longitudinal direction L towards the front portion 106. Each latching pin 164 in an extended position thereof is configured to make contact with a respective one of the opposite abutment surfaces 178, thus providing a lateral force to the respective latching pin 164 as the evacuation hatch 160 is pushed towards the closed predetermined position. When the latching pins 164 move past the rear portion 106b, they snap into the extended position and lock the evacuation hatch 160 in place.

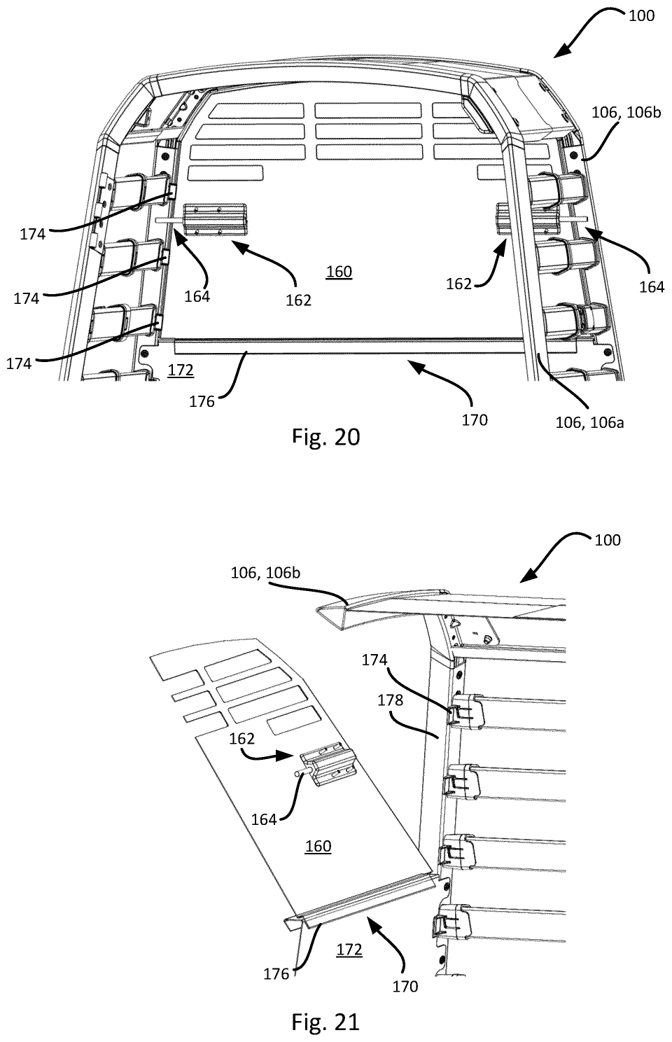

In FIG. 20, the animal cage 100 is shown in a front perspective view with the access door removed for clarity. The latching pins 164 are in their respective extended position. As illustrated, in the extended position, each latching pin 164 is arranged in a locked position in relation to the rear portion 106b of the frame arrangement 106. The evacuation hatch 160 can thus not be removed from the animal cage 100.

Further illustrated in FIG. 20 is that the evacuation hatch 160 may comprise a lower flange 176 extending along a lower edge 170 of the evacuation hatch 160. The lower flange 176 is configured to form a stop for preventing the lower edge 170 of the evacuation hatch 160 to move in the longitudinal direction L rearwardly away from the front portion 106a of the frame arrangement 106. The lower flange 176 and the latching arrangement 162 thus in cooperation forms a lock for preventing the evacuation hatch 160 to be removed from the animal cage 100. The lower flange 176 may be configured to be arranged in front of, i.e. on the side facing the front portion 160a, of a lower panel 172 of the animal cage 100. Alternatively, the lower flange 176 may cooperate with the rear portion 106b of the frame arrangement 106. The lower flange 176 preferably forms a stepped profile as the lower flange 176 is parallel to but offset from the plane in which the remainder of the evacuation hatch 160 extends. The stepped profile formed by the lower flange 176 may form a pivot point, facilitating removing and attaching the evacuation hatch 160.

The animal cage 100 may further comprise a stop 174 arranged on or in connection to the rear portion 106b of the frame arrangement 106. The stop 174 may be formed from a polymeric and/or plastic material and may in one embodiment form a part of an attachment for attaching a telescopic element 110 to the frame arrangement 106. A plurality of stops 174 may be arranged on each lateral side of the evacuation hatch 160. Each stop 174 being configured to abut against the evacuation hatch 160 and/or to prevent it from moving forwards and into the animal cage 100.

FIG. 21 shows a perspective cross-sectioned view of an animal cage 100 with the evacuation hatch 160 being moved out of the predetermined closed position. The evacuation hatch 160 is preferably configured to, when moved out of the predetermined closed position, to be removed from the animal cage in an upwardly and/or rearwardly direction, as such a movement of the evacuation hatch 160 is generally most convenient and most likely to be possible in a rear luggage space of a vehicle.

The lower flange 176 forming a stepped profile allowing the evacuation hatch 160 to pivot around the lower panel 172 facilitates the removal and attachment of the evacuation hatch 160. Moreover, as mentioned, the lower flange 176 forms a lock together with the latching arrangement 162 for preventing the evacuation hatch to move away from the front portion 106a, i.e. in the rearward longitudinal direction.

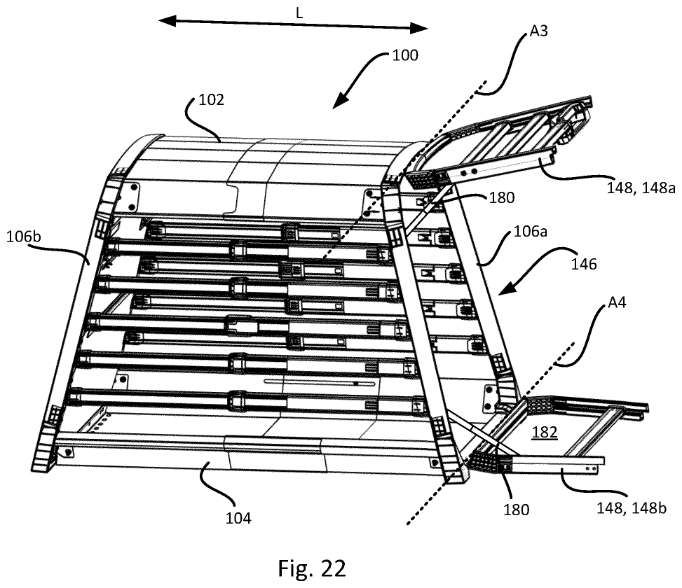

FIG. 22 discloses a perspective view of an animal cage 100 suitable for use for transportation of an animal in a vehicle. The animal cage 100 comprising:
a bottom 102,
a top 104,
a frame assembly 106 connecting the bottom 102 to the top 104, the frame assembly 106 comprising a front portion 106a and a rear portion 106b,
an access opening 146 being provided in the front portion 106a and/or the rear portion 106b, and
an access door 148 arranged in the access opening, the access door 148 having an upper portion 148a and a lower portion 148b being individually moveable between an open position and a closed position in relation to the access opening 146, wherein the upper portion 148a is configured to pivot around an upper pivot axis A3 and the lower portion 148b is configured to pivot around a lower pivot axis A4. The front portion 106a and the rear portion 106b may be configured to be reciprocally moveable as described in the foregoing.

The lower portion 148b in the open position thereof may be configured to be arranged essentially parallel with the bottom 104 of the animal cage 100. As such, the lower portion 148b may essentially form an extension of the bottom 104 in the longitudinal direction L of the animal cage 100. The lower portion 148b may be provided with a support surface 182 for providing a surface onto which an animal kept in the animal cage 100 can be arranged for facilitating extraction of the animal out of the animal cage 100.

The height of the lower portion 148b may be essentially one third of a total height of the access opening 146.

The upper portion 148a and/or the lower portion 148b may be connected to the animal cage 100 by means of a control member 180, the control member 180 may be a gas spring or a gas cylinder or another equivalent component suitable for controlling the movement of the associated lower portion 148b and/or upper portion 148a. One control member 180 may be provided to each lateral side of the upper and lower portion 148a, 148b respectively. The control member 180 may be configured to define the open position of the associated upper portion 148a, 148b of the access door 148. The control member 180 extends from the respective one of the upper portion 148a and the lower portion 148b to the front portion 106a or the rear portion 106b of the animal cage 100.

The upper pivot axis A3 and the lower pivot axis A4 are preferably essentially perpendicular to a longitudinal direction L of the animal cage. The upper pivot axis A3 is the axis around which the upper portion 148a of the access door 148 is hinged and the lower pivot axis A4 is the axis around which the lower portion 148b is hinged.

The animal cage 100 may be normally dimensionally stable but able to vary in shape by a relative movement of adjacent portions when a predefined threshold force acting on the animal cage is exceeded. The predetermined threshold force or value may be a force acting on the animal cage equivalent to a g-force equal to or higher than 14 g. By allowing a relative movement, the animal cage is capable of absorbing a force while reducing the risk of the animal cage being damaged.

For that, adjacent portions may be coupled in a way that they are guided along a predefined path relative to each other. For example, adjacent portions may be translatory coupled to each other to allow a translatory movement. In the configurations described before, the telescopic elements 110 may comprise such translatory movable portions, for example a front telescopic portion 110a and a rear telescopic portion 110b.

The stop element 140 being configured to form a limit for the telescopic movement of the front 106a and rear portion 106b such that the front portion 106a and rear portion 106b cannot move past the first relative position may be provided and the first relative position may be seen as a position in which dimensional stability is achieved through contact with the stop element 140. The animal cage can under normal use not be compressed any further. The stop element 140 may further be configured to allow relative movement of the front portion 106a and rear portion 106b past the first relative position when the animal cage 100 is subjected to a force in the longitudinal direction L being higher than a threshold value or threshold force, for instance in the case of an accident.

Adjacent portions may also be rotatably coupled to each other to allow a rotational movement. In general, a movement may be prevented by fastening the adjacent portions such that a predetermined static friction is provided between them. If forces acting on the portions are sufficiently high to overcome the static friction, the defined movement will take place.

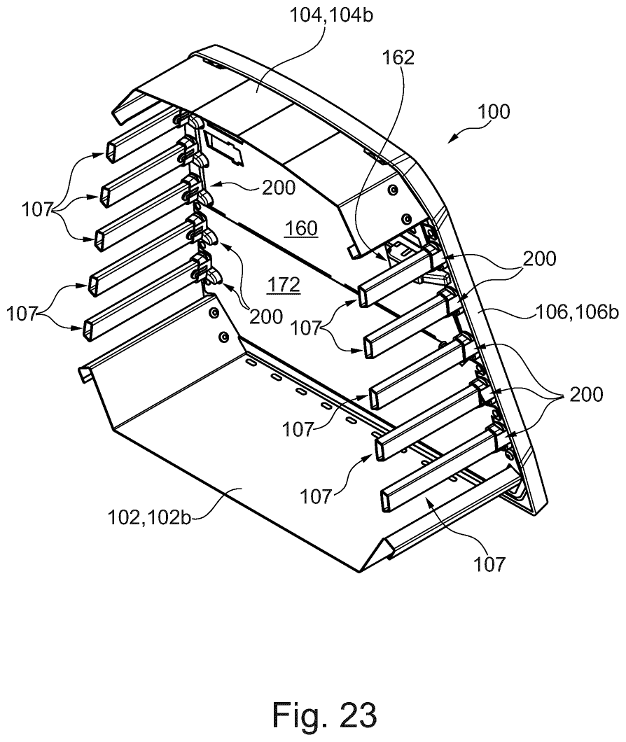

FIG. 23 shows a rear portion of an animal cage 100 according to an embodiment. The animal cage 100 may comprise a bottom 102 and a top 104 as well as a frame assembly 106 connecting the bottom 102 to the top 104. The bottom 102 may comprise one or more of the features of the bottom 102 as described before and in connection with other embodiments shown in FIGS. 1 to 22 or may be identical to the earlier described configurations of the bottom 102. The top 104 may comprise one or more of the features of the top 104 as described before and in connection with other embodiments shown in FIGS. 1 to 22 or may be identical to the earlier described configurations of the top 104. The frame assembly 106 may comprise one or more of the features of the frame assembly 106 as described before and in connection with other configurations shown in FIGS. 1 to 22. The frame assembly 106 comprises a front portion 106a as shown in the configurations of FIGS. 1 to 22 and a rear portion 106b. In FIG. 23, only a rear portion 106b is shown. Unless any differences are described in the following, the front portion and the rear portion 106b may be configured identical to the configurations of the front portion 106a and the rear portion 106b described before in connection with other aspects and in connection with the configurations in FIGS. 1 to 22.

The frame assembly 106 comprises side members 107. The side members 107 form at least a portion of a side boundary of the animal cage 100. The side members 107 may comprise telescopic elements 110 as described in connection with other aspects and in connection with the configurations described under reference to FIGS. 1 to 22.

The side members 107 are coupled to the rear portion 106b by means of a coupling arrangement 200. The coupling arrangement 200 is configured to couple an end portion of a side member 107 to the rear portion 106b such that a relative movement between the side member 107 and the rear portion 106b is possible.

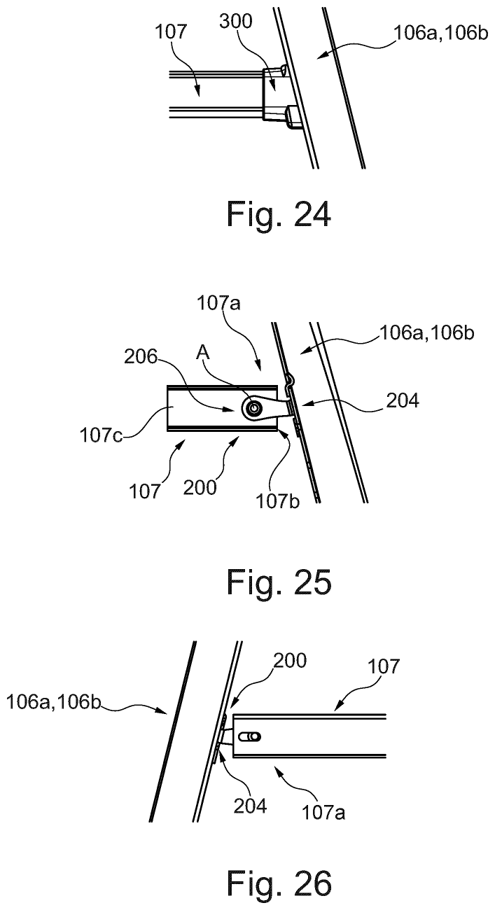

A possible configuration of the coupling arrangement 200 will be described with reference to FIGS. 24 to 28. In general, the exemplary coupling arrangement 200 is configured to couple the end portion 107a of the side member 107 to the rear portion 106b or to the front portion 106a such that the side member 107 and the rear portion 106b or the front portion 106a are rotatable relative to each other about a predetermined pivot axis A. This configuration allows the connected members to rotate relative to each other when a sufficiently high force is applied on the frame assembly 106, for example on the front portion 106a or on the rear portion 106b. In this way, an elastic deformation or plastic deformation of the side member 107 in the end portion 107a is prevented thereby reducing stresses in the material that could lead to a break of the side member or of the rear portion 106b. In this way, it is prevented that the side member 107 of the frame assembly 106 comes off of the frame assembly 106 in case of a crash.

The coupling arrangement 200 is configured to hold the side member 107 spaced apart from and rotatable with respect to the connecting portion 106a, 106b. When the side member 107 is coupled to the front portion 106a or to the rear portion 106b by means of the coupling arrangement, an end surface 107b of the side member faces the connecting portion 106b.

The coupling arrangement 200 comprises a holder 202. The holder 202 may comprise an attachment portion 204 fixedly and non-movably couplable to the connecting portion or to the side member and a coupling portion 206 couplable to the other one of the side member or the connecting portion to provide a guiding connection limiting any movement to a movement along a predetermined path. In the exemplary configurations shown in FIGS. 24 to 28, the coupling portion 206 is configured to be pivotably coupled to the side member 107. The attachment portion 204 comprises a base portion 210. The base portion 210 may be configured to be mounted in surface contact with the connecting portion 106a, 106b such that the base portion 210 can be suitably supported on the connecting portion 106a, 106b. For that, the base portion 210 may comprise a contact surface having a shape corresponding to the shape of the surface of the connecting portion 106a, 106b. For example, the base portion 210 may comprise a contact surface which is flat as is shown in FIG. 28. The base portion 210 may further comprise at least one fixation section for fixing the holder 202 on the connecting portion 106a, 106b. At least one fixation section may be configured to be directly engaged with the connecting portion. At least one fixation section may be formed to be coupled to the connecting portion by means of a coupling member, such as a screw, rivet, bolt or a coupling unit, such as a clamping arrangement.

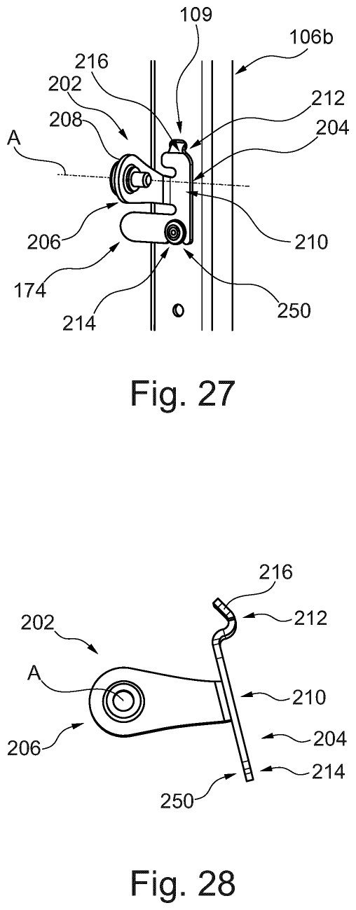

For example, the base portion 210 may comprise two fixation sections 212, 214. A first fixation section 212 may comprise an engaging portion configured to be received in an opening 109 of the connecting portion 106b. The engaging portion may comprise or may be defined as a hook portion 216 that is hooked into the opening 109 of the connecting portion 106a, 106b. The second fixation section 214 may comprise a recess, opening or cutout for receiving a coupling member 250. The first fixation section 212 and the second fixation section 214 may be provided on opposite ends or in opposite end portions of the base portion 210. With such a configuration, the holder 202 may in a first mounting step be hooked into the opening 109 via the first fixation section 212 and in a second mounting step be fixed to the connecting portion 106a, 106b by means of the coupling member 250. A mounted configuration of the holder 202 on the connecting portion 106b is shown in FIG. 27.

The base portion 210 may at least partially extend along a plane, for example between the first fixation section 212 and the second fixation section 214. The coupling portion 206 may extend from said base portion 210. For example, the coupling portion 206 may extend from said base portion 210 at an angle with respect to the above-mentioned plane. In some embodiments, the coupling portion 206 may extend from the base portion 210 in a plane that is angled with respect to the plane in which the base portion at least partially extends. The planes may extend at an angle of 90 degrees with respect to each other. The coupling portion 206 may protrude from the base portion 210 at a position between the first fixation section 212 and the second fixation section 214.

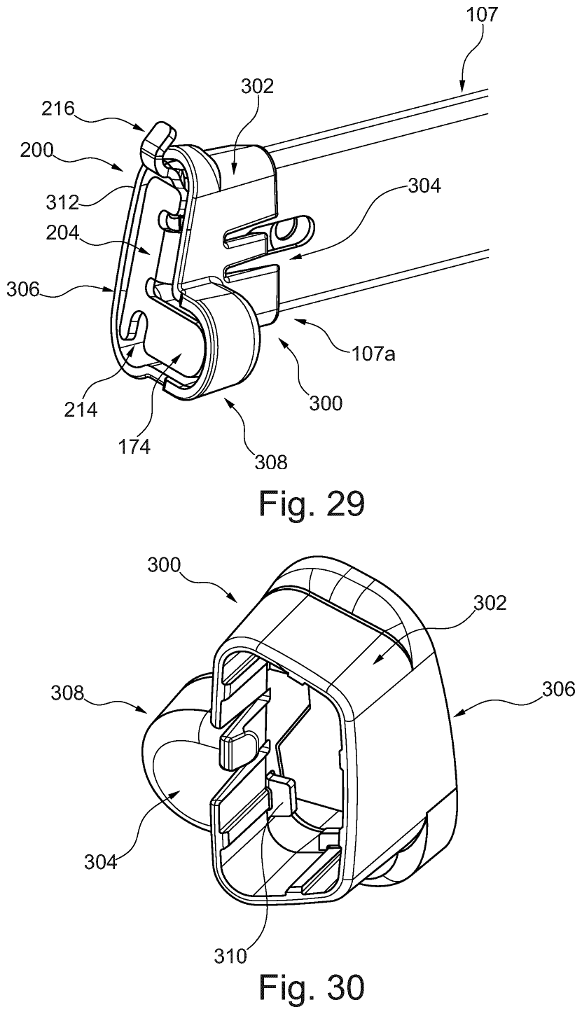

The coupling portion 206 may comprise an opening for receiving a coupling member for fixing the side member 107 to the coupling portion 206. The opening may extend in a direction perpendicular to the extension direction of the coupling portion 206. The opening extension direction conforms with an extension direction of an imaginary pivot axis formed between the coupling portion and the side member 107 when the side member 107 is mounted to the coupling portion 206 by means of a coupling member received in the opening of the coupling portion. The side member 107 may comprise an opening or slot for receiving the a coupling member as is shown in FIGS. 26 and 29. If a slot is provided, the configuration can be such that a translatory movement of the coupling member along the slot may in addition take place when the predetermined threshold force acting on the animal cage is exceeded.

The side member 107 or at least its end portion 107a may be hollow. The coupling portion 206 may be configured to be received or accommodated in the hollow end portion 107a of the side member 107. In a direction cross to the a main extension direction of the side member 107, the coupling portion 206 comprises a cross dimension that is smaller than an inner cross dimension of the side member. This allows the side member 107 to pivot about the coupling portion 206 about pivot axis A. The coupling portion 206 may be formed with a rounded edge or contour, for example following a circular path about the pivot axis A.

The coupling portion 206 may comprise a contact surface 208 which is in surface contact with an inner surface 107c of the side member 107. A contact between the contact surface 208 and the inner surface 107c may provide a predetermined static friction between the coupling portion 206 and the side member 107. A rotation of the side member 107 relative to the coupling portion 206 about the pivot axis A may thus only be possible if the static friction is overcome by an external force. Such a configuration may contribute to an arrangement in which the animal cage or frame assembly is normally rigid or dimensionally stable but may deform if an external force acting on the frame assembly exceeds a predetermined threshold force. The contact surface may be flat. The contact surface may extend perpendicular to the pivot axis. The contact surface may extend fully about the pivot axis A. The contact surface may comprise a dimension in main extension direction of the side member 107 which is larger than its dimension in a direction cross to the main extension direction of the side member. The coupling portion 206 may be formed at least partially tapering towards the attachment portion.

The holder 202 may comprise a stop portion 174. The stop portion 174 may correspond to the stop 174 already described before. In other words, the stop 174 may be integrated into the holder 202. The stop portion 174 may be configured to abut against or provide a support for an evacuation hatch 160 of the animal cage 100, for example the evacuation hatch 160 as already described in other parts of this specification, when the evacuation hatch is provided on the animal cage 100. The stop portion 174 may be provided on the holder, for example on the base portion 210 of the holder, to extend beyond the connecting portion 106b in a direction cross to the main extension direction of the connecting portion 106b and to protrude from the connecting portion 106b into an interior space of said animal cage. The stop portion 174 may be configured to extend in parallel with the pivot axis A. The stop portion 174 may be an integral part of the holder 202. For example, the holder 202 including the stop portion 174 may be formed from cutting and bending a metal sheet. In general, the holder including its different portions can be integrally formed, for example by cutting and bending a metal sheet.

The animal cage 100 may further comprise a cover portion 300. The cover portion 300 may be configured for covering a coupling section at which the side member 107 is coupled with the connecting member 106a, 106b. An exemplary cover portion 300 is shown in FIGS. 29 and 30. FIG. 29 shows a perspective view on an end portion 107a of a side member 107 into which a coupling portion 206 of a holder 202 is inserted and on which a cover portion 300 is provided. FIG. 30 shows the cover portion 300 in isolation.

The cover portion 300 may comprise a sleeve portion 302 for receiving the end portion 107a of the side member 107. The sleeve portion 302 may comprise a fixation portion 304 for attaching the cover portion 300 on the side member 107. The fixation portion 304 may be configured for a snap connection. The fixation portion 304 may comprise a hook portion configured to engage with a recess or opening on the side member 107. The recess or opening may be a slot used for fixing the coupling portion 206 of the holder 202 to the side member 107, such as the slot extending in longitudinal direction of the side member 107 as shown in FIGS. 26 and 27.

The cover portion may comprise a stop portion 310, for example a protrusion on an inner surface of the sleeve portion 302. The stop portion 310 may define a position up to which the side member 107 may be inserted into the sleeve portion. The stop portion 310 may be provided such that when said side member 107 contacts the stop portion 310, the fixation portion 304 automatically engages with a recess or opening in the side member 107.

The cover portion 300 may comprise a supporting portion 306. The supporting portion 306 may be configured to contact the connecting member 106a, 106b. The supporting portion 306 may define a contact plane for contacting the connecting member. The supporting portion 306 may comprise an edge portion or surface 312 extending in the contact plane. The contact plane may extend at an angle with respect to the main extension direction of the sleeve portion which, when the sleeve portion is mounted on the side member 107, may correspond to the main extension direction of the side member 107. The cover portion 300 may be configured to hold the side member at a predetermined orientation with respect to the connecting member 106a, 106b and may provide a predetermined resistance against a defined movement of the side member relative to the connecting portion to add rigidity to the frame assembly 106. The cover portion 300, the side member 107 and the holder 202 may be configured such that when they are coupled to each other, the contact surface of the base portion 210 and the contact plane defined by the supporting portion 306 may coincide. Accordingly, the cover portion 300 may be configured to support the side member 107 on the connecting member 106a, 106b at a predetermined angle. The cover portion 300 can be made from a deformable material. If the holder 202 comprises stop portion 174, the cover portion 300 may comprise a stop portion covering section 308 for covering the stop portion 174.

In some of the above embodiments, a relative movement (translatory movement) in the side members 107 comprising telescopic members 110 is blocked when the resistance altering element 108 is engaged. In some embodiments, a relative movement (rotation) between the side members 107 or the telescopic members 110 and the front portion 106a is normally blocked due to a tightening force provided by a connecting member and/or static friction in contact portions of adjacent movable parts. In some embodiments, in the compressed state of the animal cage, the stop element, for example a pin, may provide a limit for a movement between the front and rear portions but allows a relative movement beyond that limit when a certain force is exceeded (for example, when the stop element or pin is sheared of). As soon as an external force on the animal cage is high enough, for example in longitudinal direction, the resistance provided by the resistance altering element or provided by the connection or by the stop element will be overcome and a defined relative movement will take place.

In the following, possible features and feature combinations of the animal cage according to the second, third, fourth and fifth aspect of the disclosure are disclosed, presented as items:

### Items

A1. An animal cage (100) suitable for use for transportation of an animal in a vehicle, said animal cage (100) comprising:
a bottom (102),
a top (104),
a frame assembly (106) connecting the bottom (102) to the top (104), the frame assembly (106) comprising a front portion (106a) and a rear portion (106b),
a cage access opening (146) at least in the front portion (106a), the cage access opening (146) being provided with an access door (148) being pivotable in relation to the front portion (106a),
an access door motion control mechanism (150) being configured to provide a moment of force that varies with the opening angle (B) of the access door (148).

A2. The animal cage (100) according to item A1, wherein the motion control mechanism (150) is configured to increase the moment of force in the opening direction of the access door (148) with increasing opening angle (B) of the access door (148).

A3. The animal cage (100) according to item A1 or A2, wherein the motion control mechanism (150) comprises a constant force spring (152).

A4. The animal cage (100) according to any one of the preceding items, wherein the moment of force of the motion control mechanism (150) in or near a closed position of the access door (148) is less than an moment of force required to move the access door (148) in the opening direction.

A5. The animal cage (100) according to any one of the preceding items, wherein a hinge (154) of the access door (148) is arranged at an angle (0) in relation to a vertical direction (V) such that the access door (148) in opening angles (B) less than 90° is biased into the closed position.

A6. The animal cage (100) according to any one of the preceding items, wherein the motion control mechanism (150) is arranged between the frame assembly (106) and the access door (148) such that a moment of force in the opening direction is less near the closed position of the door (148) and increases in an opening direction of the access door (148).

A7. The animal cage (100) according to item 6 when dependent on item A5 and A3, wherein a closing moment of force acting in the closing direction from the weight of the access door (148) overcomes the moment of force in the opening direction at least at opening angles (B) less than 20° thus allowing automatic access door (148) closing.

A8. The animal cage (100) according to item A3, wherein the constant force spring (152) is arranged at a hinged side of the access door (148) and wherein an angle (γ) between an axial direction of the constant force spring (152) in which the force from the constant spring acts and a hinge (154) of the access door (148) increases with increased opening angle (B) of the access door (148).

A9. The animal cage (100) according to item A3, wherein at least one end of the constant force spring (152) is attached to the animal cage (100) by means of a ball joint.

A10. The animal cage (100) according to any one of the preceding items, wherein a lever arm distance (D4) between a hinge (154) of the access door (148) and an axial direction of the motion control mechanism (150) increases with increased opening angle (β) at least between 0° and 90° opening angle (β) thereof.

A11. The animal cage (100) according to item A10, wherein the lever arm distance (D4) is such that the motion control mechanism (150) provides a closing moment of force in a closed position of the access door (148).

A12. An animal cage (100) suitable for use for transportation of an animal in a vehicle, said animal cage (100) comprising:
a bottom (102),
a top (104),
a frame assembly (106) connecting the bottom (102) to the top (104), the frame assembly (106) comprising a front portion (106a) and a rear portion (106b),
at least one animal evacuation hatch (160) configured to allow extraction of the animal in case of emergency, the animal evacuation hatch (160) comprising a latching arrangement (162) being configured to secure the evacuation hatch (160) in relation to the frame assembly (106) such that the evacuation hatch (160) can be locked in place automatically by the latching arrangement (162) when brought into a predetermined position in relation to the frame assembly (106).

A13. The animal cage (100) according to item A12, wherein the evacuation hatch (160) is arranged in the rear portion (106b) of the animal cage (100).

A14. The animal cage (100) according to item A12 or A13, wherein the latching arrangement (162) comprises a first and a second latching arrangement (162) arranged at opposite lateral sides of the evacuation hatch (160).

A15. The animal cage (100) according to any one of the items A12 to A14, wherein each latching arrangement (162) comprises a latching pin (164) moveable between an extended and retracted position.

A16. The animal cage (100) according to item A15, wherein each latching pin (164) comprises a handle (168) for moving both the latching pin (164) and the evacuation hatch (160).

A17. The animal cage (100) according to item A15 or A16, wherein each latching pin (164) is biased into the extended position.

A18. The animal cage (100) according to any one of items A12 to A17, wherein the rear portion (106b) comprises laterally opposite abutment surfaces (178) being inclined such that a horizontal distance between the opposite abutment surfaces (178) decreases in the longitudinal direction (L) towards the front portion (106a) and wherein the evacuation hatch (160) comprises a first and second lateral flange (176) on opposite lateral sides of the evacuation hatch (160) being configured to abut against the abutment surfaces (178) to limit a forward movement of the evacuation hatch (160) towards the front portion (106a).

A19. The animal cage (100) according to item A15, wherein each latching pin (164) is configured to slide against a respective one of opposite abutment surfaces (178) of the rear portion (106b), the opposite abutment surfaces (178) being inclined such that a horizontal distance between the opposite abutment surfaces (178) decreases in the longitudinal direction (L) towards the front portion (106a), whereby each latching pin (164) is moved out of its extended position until it passes the rear portion (106b) whereby the latching pin (164) extends and locks the evacuation hatch (160) in place.

A20. The animal cage (100) according to any one of items A12 to A19, wherein the evacuation hatch (160) comprises a lower flange (176) extending along a lower edge (170) thereof, the lower flange (176) being configured to form a stop for preventing the lower edge of the evacuation hatch (160) to move away from the front portion (106a).

A21. The animal cage (100) according to item 20, wherein the lower flange (176) forms a stepped surface being offset from the remaining evacuation hatch (160), the lower flange (176) forming a pivot point around which the evacuation hatch (160) can pivot.

A22. An animal cage (100) suitable for use for transportation of an animal in a vehicle, said animal cage (100) comprising:
a bottom (102),
a top (104),
a frame assembly (106) connecting the bottom (102) to the top (104), the frame assembly (106) comprising a front portion (106a) and a rear portion (106b), the front portion (106a) and rear portion (106b) being reciprocally moveable along a longitudinal direction such that a length of the animal cage (100) may be adapted, wherein the animal cage (100) further comprises a stop element (140) being configured to form a limit for the telescopic movement of the front portion (106a) and rear portion (106b) such that the front portion (106a) and the rear portion (106b) cannot move past a first relative position and wherein the stop element (140) is configured to allow relative movement of the front portion (106a) and the rear portion (106b) past the first relative position when the animal cage (100) is subjected to a force in a longitudinal direction (L) being higher than a threshold value.

A23. The animal cage (100) according to item A22, wherein the stop element (140) comprises at least one pin (142) being configured to be sheared of by telescopic movement between the front portion (106a) and rear portion (106b) in case the animal cage (100) is subjected to a force in the longitudinal direction being higher than the threshold value.

A24. The animal cage (100) according to item A22 or A23, wherein the bottom (102) comprises a front bottom portion (102a) and a rear bottom portion (102b) and the top (104) comprises a front top portion (104a) and a rear top portion (104b), the top (104) and bottom (102) being telescopically moveable in the longitudinal direction (L) of the animal cage (100), wherein a stop element (140) is provided in the bottom (102) and/or top (104) such that relative movement of the front portion (106a) of the frame arrangement (106) and the rear portion (106b) of the frame arrangement (106) past the first relative position is only possible when the animal cage (100) is subjected to a force in the longitudinal direction (L) being higher than the threshold value.

A25. The animal cage (100) according to any one of items A22 to A24, wherein the frame assembly (106) comprises at least one telescopic element (110) extending between the front portion (106a) and the rear portion (106b), wherein a stop element (140) is provided in a front telescopic portion (110a) and/or rear telescopic portion (110b) in at least one of the at least one telescopic element (110) such that movement of the front portion (106a) and the rear portion (106b) past the first relative position is only possible when the animal cage (100) is subjected to a force in the longitudinal direction (L) being higher than the threshold value.

A26. The animal cage (100) according to item A23, wherein the pin (142) is configured to cooperate with a slot (144) such that the extension of the slot (144) defines the first relative position and wherein the pin (142) is configured to be sheared by engagement of an end (144a, 144b) of the slot (144).

A27. The animal cage (100) according to item A23 or A26, wherein the pin (142) is configured to be sheared before plastic deformation is achieved in the slot (144).

A28. The animal cage (100) according to any one of items A23, A26 or A27, wherein the pin (142) is releasably attached to the animal cage (100) such that it can be replaced.

A29. An animal cage (100) suitable for use for transportation of an animal in a vehicle, said animal cage (100) comprising:
a bottom (102),
a top (104),
a frame assembly (106) connecting the bottom (102) to the top (104), the frame assembly (106) comprising a front portion (106a) and a rear portion (106b),
an access opening (146) being provided in the front portion (106a) and/or the rear portion (106b), and
an access door (148) arranged in the access opening, the access door (148) having an upper portion (148a) and a lower portion (148b) being individually moveable between an open position and a closed position in relation to the access opening (146), wherein the upper portion (148a) is configured to pivot around an upper pivot axis (A3) and the lower portion (148b) is configured to pivot around a lower pivot axis (A4).

A30. The animal cage (100) according to item A29, wherein the lower portion (148b) in the open position thereof is configured to be arranged essentially parallel with the bottom (104) of the animal cage (100).

A31. The animal cage (100) according to item A29 or A30, wherein the height of the lower portion (148b) is essentially one third of a total height of the access opening.

A32. The animal cage (100) according to any one of items A29 to A31, wherein the upper portion (148a) and/or the lower portion (148b) is connected to animal cage (100) by means of a control member (180).

A33. The animal cage (100) according to any one of items A29 to A32, wherein the upper pivot axis (A3) and the lower pivot axis (A4) are essentially perpendicular to a longitudinal direction (L) of the animal cage (100).

A34. An animal cage (100) suitable for use for transportation of an animal in a vehicle, said animal cage (100) comprising:
a bottom (102),
a top (104),
a frame assembly (106) comprising a connecting portion (106a, 106b) connecting the bottom (102) to the top (104) and a side member (107) forming at least a portion of a side boundary of said animal cage (100),
wherein preferably, in a use configuration, said animal cage (100) is configured to be dimensionally stable as long as a force acting on the animal cage (100) is lower than a predetermined force, and, when said force is higher than said predetermined force, to at least partially vary in shape through a relative movement, in particular a translatory and/or rotatory movement, of adjacent portions of said frame assembly, said bottom (102) and/or said top (104) with respect to each other.

A35. Animal cage (100) according to item A34,
wherein said side member (107) and said connecting portion (106a, 106b) are coupled to each other to allow a defined relative movement between said side member (107) and said connecting portion (106a, 106b).

A36. Animal cage (100) according to item A35, wherein said side member (107) is coupled to said connecting portion (106a, 106b) by means of a coupling arrangement (200) configured to hold said side member (107) spaced apart from and rotatable with respect to said connecting portion (106a, 106b).

A37. Animal cage (100) according to item A36, wherein said side member (107) comprises a main extension direction and is coupled to said connecting portion (106a, 106b) such that an end surface portion (107b) of the side member (107) faces said connecting portion (106a, 106b) in said main extension direction.

A38. Animal cage (100) according to item A36 or item A37, wherein said coupling arrangement (200) comprises a holder (202) with an attachment portion (204) fixedly and non-moveably coupled to one of said connecting portion (106a, 106b) or said side member (107), and with a coupling portion (206) pivotably coupled to the other one of said side member (107) or said connecting portion (106a, 106b) about a pivot axis (A).

A39. Animal cage (100) according to item A38, wherein said side member (107) comprises a hollow end portion (107a) and said coupling portion (206) is accommodated in said hollow end portion (107a) of said side member (107).

A40. Animal cage (100) according to item A39, wherein in a direction cross to said main extension direction of said side member (107) said coupling portion (206) comprises a cross dimension that is smaller than an inner cross dimension of said side member (107) to allow for a movement of said side member (107) relative to said coupling portion (206) about said pivot axis (A).

A41. Animal cage (100) according to one of items A38 to A40, wherein said coupling portion (206) comprises a contact surface (208) which is in contact with an inner surface (107c) of said side member (107), wherein said contact surface (208) may be flat and/or may extend perpendicular to said pivot axis (A), and wherein said contact surface (208) may preferably fully extend about said pivot axis (A) and/or may comprise a dimension in main extension direction of said side member (107) which is larger than its dimension in a direction cross to the main extension direction of said side member (107), wherein said coupling portion (206) may be formed tapering towards the attachment portion (204).

A42. Animal cage (100) according to one of items A38 to A41, wherein said attachment portion (204) comprises a base portion (210) extending along a main extension direction of said connecting portion (106a, 106b) and at least partially contacting an outer surface of said connecting portion (106a, 106b).

A43. Animal cage (100) according to item A42, wherein said base portion (210) comprises at least one fixation section (212, 214) for attaching said holder (202) to said connecting portion (106a, 106b), wherein at least one fixation section (212) may comprise a hook portion (216) hooked into an opening (109) of said connecting portion (106a, 106b) or may comprise a recess for receiving a coupling member (250).

A44. Animal cage (100) according to one of items A38 to A43, wherein said holder (202) comprises a stop portion (174) configured to abut against an evacuation hatch (160) of said animal cage (100), wherein said stop portion (174) may be provided on said holder (202) to protrude beyond said connecting portion (106a, 106b) in a direction cross to the main extension direction of said connecting portion (106a, 106b).

A45. Animal cage (100) according to one of items A38 to A44, wherein said holder (202) including its different portions is integrally formed, for example by cutting and bending a metal sheet.

A46. Animal cage (100) according to one of items A35 to A45, further comprising a cover portion (300) for covering a coupling section at which said side member (107) is coupled with said connecting member (106a, 106b), said cover portion (300) preferably comprising a sleeve portion (302) for receiving an end portion (107a) of said side member (107) and/or a fixation portion (304) for attaching said cover portion (300) on said side member (107) and/or a supporting portion (306) configured to contact said connecting member (106a, 106b), wherein a main extension direction of said sleeve portion (302) and a contact plane defined by said supporting portion (306) may extend at an angle with respect to each other, and wherein in addition or alternatively said cover portion (300) is configured to hold said side member (107) at a predetermined orientation with respect to said connecting member (106a, 106b) and provides a predetermined resistance against said defined movement between said side member (107) and said connecting portion (106a, 106b) to add rigidity to the frame assembly (106).

A47. Animal cage (100) according to one of items A35 to A46, wherein said connecting portion (106a, 106b) is a front portion (106a) or a rear portion (106b) of said frame assembly (106) and/or wherein said side member (107) may comprise a telescopic element (110), for example a telescopic element (110) as defined in item A25 or in items A52, A53 or A54, and/or wherein said front portion (106a) and said rear portion (106b) are reciprocally moveable relative one another along a longitudinal direction (L) of the animal cage (100) such that a length of the animal cage (100) may be adapted.

A48. Animal cage (100) according to item A47, comprising at least one resistance altering element (108) having at least one pre-set force state for altering a longitudinal force required for relative movement of the front (106a) and rear portion (106b), for example a resistance altering element as defined in A50, A51, A53, A54, A56, A60 or A61 and/or comprising a stop element (140) being configured to form a limit for the telescopic movement of the front portion (106a) and rear portion (106b) such that the front portion (106a) and the rear portion (106b) cannot move past a first relative position and wherein the stop element (140) is configured to allow relative movement of the front portion (106a) and the rear portion (106b) past the first relative position when the animal cage (100) is subjected to a force in a longitudinal direction (L) being higher than a threshold value.

A49. An animal cage (100) suitable for use for transportation of an animal in a vehicle, said animal cage (100) comprising:
a bottom (102),
a top (104),
a frame assembly (106) connecting the bottom (102) to the top (104), the frame assembly (106) comprising a front portion (106a) and a rear portion (106b), the front portion (106a) and rear portion (106b) being reciprocally moveable relative one another along a longitudinal direction (L) of the animal cage (100) such that a length of the animal cage (100) may be adapted and wherein the animal cage (100) comprises at least one resistance altering element (108) having at least one pre-set force state for altering a longitudinal force required for relative movement of the front (106a) and rear portion (106b).

A50. The animal cage (100) according to item A49, wherein the resistance altering element (108) can be set to at least a high force state in which the longitudinal force required for relative movement of the front portion (106a) and rear portion (106b) is high and a low force state in which the longitudinal force required for relative movement of the front portion (106a) and rear portion (106b) is low relative the high force state.

A51. The animal cage (100) according to items A49 or A50, wherein the resistance altering element (108) comprises a clamp mechanism (122) configured to alter a pressure applied to an interface (134) for controlling an induced friction force thus altering the longitudinal force required for relative movement of the front portion (106a) and rear portion (106b).

A52. The animal cage (100) according to any one of items A49 to A51, wherein the frame assembly (106) comprises at least one telescopic element (110) extending between the front portion (106a) and the rear portion (106b) and wherein at least one of the at least one telescopic element (110) is provided with the resistance altering element (108).

A53. The animal cage (100) according to item A52, wherein the frame assembly (106) comprises a plurality of telescopic elements (110) provided on each lateral side of the animal cage (100).

A54. The animal cage (100) according to item A52 or A53, wherein at least one telescopic element (110) on each lateral side of the animal cage (100) is provided with a resistance altering element (108).

A55. The animal cage (100) according to item A51, wherein the clamp mechanism (122) is configured to be set in a clamping state in which the pressure applied to the interface (134) is high and in a released state in which the pressure applied to the interface (134) is low.

A56. The animal cage (100) according to any one of items A49 to A55, wherein the resistance altering element (108) comprises a cam surface (126) configured to alter the force required for telescopic movement of the front and rear portion (106b).

A57. The animal cage (100) according to item A56 when dependent on item A51, wherein the clamp mechanism (122) controls the position of the cam surface (126).

A58. The animal cage (100) according to item A50, wherein the longitudinal force required for achieving relative movement of the front portion (106a) and rear portion (106b) in the high force state corresponds to at least half of a total weight of the animal cage (100).

A59. The animal cage (100) according to item A58, wherein the longitudinal force required for achieving relative movement of the front portion (106a) and rear portion (106b) in the high force state is between 50 N and 200 N.

A60. The animal cage (100) according to item A54, wherein the telescopic element (110) provided with the resistance altering element (108) is arranged at a height from the bottom (102) of the animal cage (100) in the proximity of a height from the bottom (102) of the animal cage (100) of a center of gravity of said animal cage (100).

A61. The animal cage (100) according to item A54, wherein the telescopic element (110) provided with the resistance altering element (108) is arranged at a height from the bottom (102) of the animal cage (100) that is essentially half of a total height of the animal cage (100).

A62. The animal cage (100) according to any one of items A49 to A61, wherein the animal cage (100) further comprises a stop element (140) being configured to form a limit for the relative movement of the front portion (106a) and rear portion (106b) such that the front portion (106a) and rear portion (106b) cannot move past a first relative position and wherein the stop element (140) is configured to allow movement of the front portion (106a) and rear portion (106b) past the first relative position when the animal cage (100) is subjected to a longitudinal force being higher than a threshold value.

A63. The animal cage (100) according to item A62, wherein the threshold value of the longitudinal force is at least half of the weight of the animal cage (100).

It is to be understood that the present invention is not limited to the embodiments described above and illustrated in the drawings; rather, the skilled person will recognize that many changes and modifications may be made within the scope of the appended claims.

1-15. (canceled)

16. An animal crate for transporting an animal in a vehicle, the animal crate comprising:
a bottom and a top connected by a frame assembly, wherein the frame assembly comprises a front portion, a rear portion, and an elongate member connected to the front portion and the rear portion,
wherein the front portion and the rear portion are configured to translate relative to each other in a longitudinal direction.

17. The animal crate of claim 16, further comprising at least one stay configured to limit the relative translation of the front portion and the rear portion at a relative position.

18. The animal crate of claim 17, wherein the stay comprises a clamp and a base portion, and wherein a portion of the elongate member extends through the base portion.

19. The animal crate of claim 17, wherein the clamp is hingedly coupled to the base portion.

20. The animal crate of claim 17, wherein the clamp engages the elongate member when the stay is in a closed state.

21. The animal crate of claim 17, wherein the front portion and the rear portion are configured to translate relative to each other in response to a first longitudinal force when the stay is in an open state, and wherein the front portion and the rear portion are configured to translate relative to each other in response to a second longitudinal force when the stay is in a closed state, and wherein the second longitudinal force is greater than the first longitudinal force.

22. The animal crate of claim 17, wherein the stay further comprises a cam surface extending from the clamp, and wherein the cam surface is configured to protrude into the base portion and contact the elongate member.

23. The animal crate of claim 16, wherein the elongate member extends along a plane that is approximately coplanar with a center of gravity of the animal crate, and approximately parallel with the bottom of the crate.

24. The animal crate of claim 16, wherein the elongate member extends at a height that is approximately half of a total height of the animal crate.

25. The animal crate of claim 16, wherein the frame assembly further comprises a first lateral portion comprising the elongate member, and a second lateral portion comprising a second elongate member connected to the front portion and the rear portion.

26. The animal crate of claim 25, further comprising a second stay coupled to the second elongate member.

27. The animal crate of claim 16, wherein the elongate member is a telescoping element.

28. The animal crate of claim 16, wherein the stay is a stop element configured to limit the relative translation of the front portion and the rear portion at a first relative position when the animal crate is subject to a first longitudinal force that is less than a threshold value, and configured to allow the relative translation of the front portion and the rear portion at the first relative position when the animal crate is subjected to a force that is greater than the threshold value.

29. The animal crate of claim 28, wherein the stop element comprises a slot and a pin disposed in the slot.

30. The animal crate of claim 29, wherein the pin is configured to shear in response to a threshold longitudinal force.

31. The animal crate of claim 29, wherein a shear strength of the pin is less than a yield strength of the slot.

32. The animal crate of claim 29, wherein the pin is removably disposed within the slot.

33. The animal crate of claim 28, wherein the stop element is disposed in the elongate member or the bottom of the animal crate or the top of the animal crate.

34. An animal crate for transporting an animal in a vehicle, the animal crate comprising:
a bottom and a top connected by a frame assembly;
an elongate member connected to a front portion of the frame assembly and a rear portion of the frame assembly;
a stay configured to limit a relative translation of the rear portion and the front portion; and
a stop element configured to limit the relative translation of the front portion and the rear portion when the animal crate is subject to a first longitudinal force that is less than a threshold value.

35. The animal crate of claim 34, wherein the stay comprises a clamp and a base portion, and wherein a portion of the elongate member extends through the base portion.
